(19) United States
(12) Patent Application Publication
(10) Pub. No.: US 2016/0095331 A1
(43) Pub. Date: Apr. 7, 2016

(54) COLORED WAX COMPOSITIONS

(71) Applicant: INTERCONTINENTAL GREAT BRANDS LLC, East Hanover, NJ (US)

(72) Inventors: Kishor Kabse, Morris Plains, NJ (US); Milton Bowen, Blakeslee, PA (US)

(73) Assignee: INTERCONTINENTAL GREAT BRANDS LLC, East Hanover, NJ (US)

(21) Appl. No.: 14/786,222

(22) PCT Filed: Apr. 28, 2014
(86) PCT No.: PCT/US2014/035647

§ 371 Date: Oct. 22, 2015

Related U.S. Application Data
(60) Provisional application No. 61/817,613, filed on Apr. 30, 2013.

(51) Int. Cl. A23G 4/20; A23L 1/275; A23G 4/06; A23L 1/00; A23G 3/34; A23G 3/54

(52) U.S. Cl. CPC A23G 4/20; A23G 3/0085; A23G 3/343; A23G 3/54; A23G 4/062; A23L 1/0055; A23L 1/275; A23V 2002/00

(57) ABSTRACT

Colored wax compositions comprising a multiplicity of colored wax particles comprising at least one wax, at least one colorant and at least one emulsifier, wherein the colored wax particles are made by heating the at least one wax, the at least one colorant and the at least one emulsifier together, solidifying the melted colored wax composition and then forming particles from the solidified colored wax composition, the resultant colored wax particles having an average particle size of at least 200 microns that provide a speckled appearance when applied to the surface of a confectionery composition. In particularly, the present disclosure relates to coated confectionery compositions such as chewing gum compositions having a speckled appearance when this colored wax composition is applied as a coating to a confectionery composition as well as to methods for making colored wax coated confectionery compositions such as chewing gum pellets.

### CROSS-REFERENCE TO RELATED APPLICATION

This application claims the benefit of U.S. Provisional Patent Application Ser. No. 61/817,613 filed Apr. 30, 2013. The related application is incorporated herein by reference.

### FIELD

This disclosure relates to colored wax compositions that provide a speckled appearance when applied in a confectionery composition. More particularly, the present disclosure relates to coated chewing gum compositions having a speckled appearance when a colored wax composition is applied to a chewing gum composition as well as to methods for making colored wax confectionery compositions such as chewing gum pellets.

### BACKGROUND

Coatings are included on confectionery compositions such as chewing gum products for a variety of purposes including providing a color or texture, for providing a flavor, for protection of the core, for providing visual effects, and the like.

One form of chewing gum products are coated pellets. These are coated with either sugar or sugarless polyol coatings known as pannings. In pannings, a polyol coating solution is applied to gum centers and dried in repeated steps to build up a layer of the coating. Pannings may be hard pannings or soft pannings, the difference being that in soft pannings, powdered sweeteners are added between the successive polyol applications to help hold up the coating layer and dry the solution. In hard pannings, these powdered sweeteners are not added as profusely, though may be added in small quantities and intermittently. The polyol coatings so produced may be either smooth to have a mottled appearance, and is often colored be the addition of a colorant to the coating solution. Coated gum pellets are often polished using a micronized or finely powdered wax such as carnauba wax sprinkled on the gum pellet surface and tumbled in the coating pan to achieve a smooth surface. This outer wax coating surface provides a polished gloss to the underlying coated pellets and works as a moisture barrier being hydrophobic in nature. Also, this wax polishing layer helps the pellets flow through high speed wrapping equipment.

U.S. Pat. No. 5,171,589 (Richey et al.) teaches the use of a colored wax in a polishing step to improve the colored appearance on colored coated gum pellets. That process for making coated gum products includes the steps of providing a gum center, coating the gum center with a colored coating and applying a polishing layer containing a wax and a colorant to the colored coated gum center. The wax particles in this patent are described to be less than 150 microns and, preferably less than 45 microns (see column 5, lines 30-44) and the gum pellets were solidly single colored and a speckled colored appearance was not desired. (see the Examples, particularly the description of Comparative Example 5 at column 6, lines 60-66).

Speckled colored confectionery compositions such as chewing gum pellets are commercially desired. However, adding colorants during the coating solution panning steps can lead to certain processing problems such as color bleeding and defects in color shading and uniform spreading on the surface. Also, the amount of color added to the pannings may be relative large and thus can be expensive. Moreover, the addition of the overlying wax polishing coating layer further diminishes the color aesthetics of the final colored product. Also, more colorant is needed to be added in the underlying panning layers to achieve the desired degree of color since the wax-overcoating will diminish the color in those underlying panning layers. Thus, there is a need for better speckled colored confectionery compositions that overcomes those problems.

### SUMMARY

In one embodiment, there is provided a colored wax composition comprising a multiplicity of colored wax particles comprising at least one wax, at least one colorant and at least one emulsifier, wherein the colored wax particles are made by heating the at least one wax, the at least one colorant and the at least one emulsifier together, solidifying the melted colored wax composition and then forming particles from the solidified colored wax composition, the resultant colored wax particles having an average particle size of at least 200 microns and are capable of forming speckles in a confectionery product.

In another embodiment, there is provided a multi-region confectionery composition comprising: a first region comprising a confectionery base; a second region at least partially surrounding the first region, the second region comprising a multiplicity of colored wax particles comprising at least one wax, at least one colorant and at least one emulsifier, wherein the colored wax particles are made by heating the at least one wax, the at least one colorant and the at least one emulsifier together, solidifying the melted colored wax composition and then forming particles from the solidified colored wax composition, the resultant colored wax particles having an average particle size of at least 200 microns and are capable of forming speckles in the multi-region confectionery composition.

In another embodiment, there is provided a method of making a speckled colored coated confectionery composition comprising the steps of: (a) providing a confectionery base having an outer surface; and (b) applying a colored wax composition to at least a portion of the outer surface of the confectionery base; the colored wax composition comprising a multiplicity of colored wax particles comprising at least one wax, at least one colorant and at least one emulsifier, wherein the colored wax particles are made by heating the at least one wax, the at least one colorant and the at least one emulsifier together, solidifying the heated colored wax composition and then forming particles from the solidified colored wax composition, the resultant colored wax particles having an average particle size of at least 200 microns and are capable of forming speckles in the confectionery product.

In another embodiment, there is provided a colored wax composition comprising: a solidified liquid mixture of at least one liquid carrier, at least one wax, at least one colorant and at least one emulsifier and is capable of forming colored wax speckles in a confectionery product, wherein the mixture comprises (a) about 2% to about 30% by weight liquid carrier; (b) about 50% to about 95% of the at least one wax; (c) about 0.1% to about 3% by weight of the at least one colorant; and (d) about 1% to about 20% by weight of the at least one emulsifier.

In another embodiment, there is provided a multi-region confectionery composition comprising: a first region comprising a confectionery base; and a second region at least partially surrounding the first region, the second region comprising a colored wax composition, wherein the colored wax composition is a solidified liquid mixture of at least one liquid carrier, at least one wax, at least one colorant and at least one emulsifier and is capable of forming colored wax speckles in the confectionery composition, wherein the mixture comprises (a) about 2% to about 30% by weight liquid carrier; (b) about 50% to about 95% of the at least one wax; (c) about 0.1% to about 3% by weight of the at least one colorant; and (d) about 1% to about 20% by weight of the at least one emulsifier.

In another embodiment, there is provided a method of making a speckled colored coated confectionery composition comprising the steps of: (a) providing a confectionery base having an outer surface; and (b) applying a colored wax composition to at least a portion of the outer surface of the confectionery base; the colored wax coating composition comprising a solidified liquid mixture of at least one liquid carrier, at least one wax, at least one colorant and at least one emulsifier and is capable of forming colored wax speckles in the confectionery composition, wherein the mixture comprises (a) about 2% to about 30% by weight liquid carrier; (b) about 50% to about 95% of the at least one wax; (c) about 0.1% to about 3% by weight of the at least one colorant; and (d) about 1% to about 20% by weight of the at least one emulsifier.

The present invention provides wide variations in speckle properties on a confectionery product such as chewing gum. If the average particle size of the colored wax particles is relatively large (e.g., around 1000 microns), then the resulting speckles on the confectionery product will be large and loosely populated per unit area. If the average particle size is relatively small (e.g., around 200 microns), the resulting speckles will be small and densely packed per unit area. Combinations of large and small speckles may be employed to provide a different visual effect. Mono-colored speckles may be made by using one colorant or multi-colored speckles may be obtained be using multiple multi-colored wax particles. Also, the color intensity of the speckles may be varied by either having a higher percentage of colorant in the particles to produce darker colored speckles or having a lower percentage of colorant to produce lighter colored speckles. Mixtures of darker colored with lighter colored speckles may also be used. Mono or multicolored speckles may be distributed over an underlying continuous colored area to further highlight the speckles. Also, speckles of the different shapes and thicknesses such as round, rectangular, square, curved or straight shapes may also be used. Further, the colorant from the speckles may be allowed to bleed out in small proportions to give a smudged color appearance on the surface of the confectionery product. Combinations of the above parameters give the manufacturer of confectionery products a wide latitude for making different speckled colored products.

The above described and other embodiments are exemplified by the following detailed description.

### DETAILED DESCRIPTION

As used herein, the term “confectionery composition” or “confectionery” or “confectionery base” means an edible product comprising a sweet component. Confectionery compositions include medicinal preparations made with sugar, syrup, or honey, and sweet foods such as candy or pastry. Suitable confectionery compositions are well known in the art and include “sugar confectionery” such as hard candy (including, for example, amorphous sugar-glass), toffees, fudge, fondants, jellies, gummies, pastels, caramel, taffy, nougat, and chewing gum as well as “fat-based confectionery” such as chocolate (including, for example, milk chocolate, dark chocolate, and semi-sweet chocolate), and coatings including, for example, chocolate compound coatings, pastel compound coatings such as white chocolate, and the like.

The “confectionery base” also covers a wide variety of confectionery cores including, but not limited to, a gum center or gum core, a center-filled confectionery, a chewable confectionery, a crunchy confectionery, a low boiled confectionery, a hard boiled confectionery, a fondant, a caramel, a jelly, a gummy, a nougat, an edible film, a nut paste, chocolate, fudge, or a combination comprising at least one of the foregoing confectionery cores.

The terms “coating” or “coating region” are used to refer to a region of a material that at least partially surrounds the confectionery core. Colored wax coatings may be referred to as “polishing” compositions or mixtures or “coating” compositions or mixtures. Confections with such colored wax coatings may be referred to as either polishing layers or coating layers.

The terms “surround,” “surrounding,” “at least partially surrounding,” and the like are not limited to encircling. These terms can refer to enclosing or confining on all sides, encircling or enveloping, and are not limited to symmetrical or identical thicknesses.

The term “substantially covers” refers to coating compositions that cover more than 50% of the surface area of a chewing gum core. In other embodiments, “substantially covers” may refer to coverage that is more than 55%, more than 60%, more than 65%, more than 70%, more than 75%, more than 80%, more than 85%, more than 90%, more than 95%, more than 98%, and more than 99% of the surface are of a chewing gum core.

The colored wax compositions described herein are designed to provide a polished colored surface over the confectionery bases or cores of the present invention. One or more intermediate layers such as hard or soft panning layers may lie between the confectionery cores and the colored wax coated surfaces. The colored wax compositions described herein are made from four (4) different types of ingredients, namely, a liquid carrier such as water or glycerin, at least one colorant, at least one wax, and at least one emulsifier. Other ingredients may be added to these colored wax compositions.

The liquid carrier is employed to assist the other three ingredients to be mixed together and to allow the emulsifier to act as a surfactant to bring together the wax phase and the colorant phase. Any suitable liquid carrier may be used. Water is the most desirable. Glycerin is also desirable for some lakes and dyes. The amount of the liquid carrier is from about 2% to about 30% by weight of the solidified liquid mixture. More desirably, the amount of the liquid carrier is from about 3% to about 20% by weight of the solidified liquid mixture.

Any edible food color may be suitable for use as the colorant in these colored wax compositions. Suitable edible colorants include: the food dyes approved for human consumption under the Food, Drug and Cosmetic Act administered by the U.S. Food and Drug Administration (FDA), referred to herein as “FD&C dyes”; natural colorants derived from natural (usually vegetable) sources which are generally assumed to be safe for human consumption; colorants derived from natural sources which are FDA-approved; and synthetic colorants approved for use in non-U.S. jurisdictions. Also includes are pigments and lakes. Lakes are especially desirable because they provide bright vivid colors in the wax coating compared to dyes.

As colorants in connection with the present invention, any of the known FD&C dyes may be used, including without limitation, Red No. 3 (Erythrosine), Red No. 40 (Allura Red), Yellow No. 6 (Sunset Yellow FCF), Yellow No. 5 (Tartrazine), Green No. 3 (Fast Green FCF), Blue No. 1 (Brilliant Blue FCF), Blue No. 2 (Indigotine), FD&C Blue #2, FD&C Green #3, tartrazine (E102), quinoline yellow (E104), sunset yellow (E110), ponceau (E124), erythrosine (E127), patent blue V (E131), titanium dioxide (E171), aluminium (E173), allura red, silver (E174), gold (E175), pigment rubine/lithol rubine BK (E180), calcium carbonate (E170), carbon black (E153), black PN/brilliant black BN (E151), brown HT, green S, green S/acid brilliant green BS (E142), and a combination comprising at least one of the foregoing food colors. Exemplary natural colorants include, without limitation, annatto seed extract, anthocyanins (found in various berries, grapes, cabbage, and cranberries), caretenoids (found in carrots), betalins, and oleoresins (from roots such as turmeric, paprika, carmines, beet roots, and tomatoes). Pigments and lakes may also be used as the colorant according to the invention. A pigment consists of fine, usually inorganic particles used to impart color when dispersed in the base. Examples of pigments include, without limitation, kaolin, chalk, titanium dioxide and aluminum hydroxide. A lake comprises fine particles, such as aluminum hydroxide particles bound to a colorant, such as one of the FD&C dyes or natural colorants mentioned above. Examples include, without limitation, FD&C Blue #1 Lake, FD&C Blue #2 Lake, FD&C Yellow #5 Lake, FD&C Yellow #6 Lake, Erythrosine Lake, Amaranth Lake, Ponceau 4R Lake, Carmoisine Lake, Sour Green Apple Lake 09225, Blue Opatinit G-10529 Lake, and FD&C Red 40 Lake, all of which may be obtained from the Warner Jenkinson Company, St. Louis, Mo. Depending upon the type of speckles desired as mentioned above, the amount of the colorant is from about 0.1% to about 3% by weight of the solidified liquid mixture. More desirably, the amount of the colorant is from about 0.3% to about 2% by weight of the solidified liquid mixture.

Any wax useful in foods may be used in these colored wax compositions. These include carnauba wax, bees wax, candelilla wax, spermaceti wax and mixtures thereof. Other high melting waxes include vegetable wax, rice bran wax, polyethylene wax, microcrystalline wax, most petroleum waxes, and the like, and mixtures thereof. The amount of the wax is from about 50% to about 95% by weight of the solidified liquid mixture. More desirably, the amount of the wax is from about 55% to about 90% by weight of the solidified liquid mixture.

Any emulsifier commonly used in foods may be used in these colored wax compositions. Suitable emulsifiers include distilled monoglycerides, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl monostearate, glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, tweens, spans, stearoyl lactylates, calcium stearoyl-2-lactylate, sodium stearoyl-2-lactylate, lecithin, ammonium phosphatide, sucrose esters of fatty acids, sucroglycerides, propane-1,2-diol esters of fatty acids, and a combination thereof. A combination of glycerol monostearate and lecithin is desirable. In some embodiments, lecithin and glyceryl monostearate are used in a weight ratio of about 10:1 to about 1:10. The amount of the emulsifier is from about 1% to about 20% by weight of the solidified liquid mixture. More desirably, the amount of the emulsifier is from about 2% to about 10% by weight of the solidified liquid mixture.

For one embodiment, the colored wax composition is an aqueous mixture in the polishing layer and comprises (a) about 3% to about 20% by weight water; (b) about 55% to about 90% of the at least one wax; (c) about 0.3% to about 2% by weight of the at least one colorant; and (d) about 2% to about 10% by weight of the at least one emulsifier.

The colored wax composition is prepared by mixing water with the at least one colorant: heating the at least one wax: adding the at least one emulsifier and at least one mixture of water with the at least one colorant to the molten wax to form a colored wax mixture; then solidifying the resultant mixture into a solid colored wax material; and then grinding that solid colored wax material into particles having an average particle size of greater than 200 microns. It may be desirable to have the average particle size of the at least one wax from about 400 microns to about 1000 microns. The heating is carried out from about 60 degrees C. to about 80 degrees C.

These colored wax particles are then added to the confectionery base composition that may or may not have been previously coated with one or more intermediate layers (third region). The at least one intermediate coating (third region) may be at least one polyol coating. This addition can be carried out in the same hard panning apparatus used to form an outer polishing coating that has a speckled coloring from the colored wax composition. In some embodiments, the amount of colored wax composition may be from about 0.005% to 1.0% by weight of the confectionery composition.

Disclosed herein are coated chewing gum compositions having a speckled colored wax coating. In some embodiments, the coated chewing gum comprises a gum core comprising a gum base, and a colored wax coating composition at least partially surrounding the gum core; wherein the colored wax coating composition is made from a solidified aqueous mixture of at least one wax, at least one colorant and at least one emulsifier and forms a speckled colored wax coating on the coated chewing gum composition.

In other embodiments, the confectionery base composition is a gum center that is optionally coated with at least one layer of sugar or sugarless polyol before the colored wax composition is applied. The polyol coating generally comprises a sugarless sweetener selected from the group consisting of sorbitol, mannitol, isomalt, xylitol, maltitol, erythritol, lactitol and combinations thereof. In this embodiment, the amount of polyol coating coated onto the gum center may be from about 10% to 100% by weight of the gum center. One or more of the polyol coating may contain a colorant such as titanium dioxide to provide a neutral background color to the speckled coloring of the colored wax polishing layer. The at least one polyol coating may be added to the gum center by conventional panning techniques, including both hard and soft panning processes. After the at least one intermediate polyol coating, if any, is applied, the colored wax composition is applied to make a speckled colored chewing gum pellet. As used herein, the terms “gum,” “chewing gum,” and “bubble gum” are used interchangeably and are meant to include any gum composition. With regard to chewing gum compositions, such compositions contain a gum base, the flavor enhancing composition, and various additives.

The gum center compositions disclosed herein can be in the form of slabs, sticks, pellets, balls, and the like. The composition of the different forms of the gum centers will be similar but can vary with regard to the ratio of the ingredients. For example, coated gum compositions can contain a lower percentage of softeners. Pellets and balls can have a chewing gum core, which has been coated with either a sugar solution or a sugarless or polyol solution to create the hard shell. Slabs and sticks are usually formulated to be softer in texture than the chewing gum core. In some cases, a hydroxy fatty acid salt or other surfactant actives can have a softening effect on the gum base. In order to adjust for any potential undesirable softening effect that the surfactant actives can have on the gum base, it can be beneficial to formulate a slab or stick gum having a firmer texture than usual (i.e., use less conventional softener than is typically employed).

Center-filled gum is another common gum form. The gum portion has a similar composition and mode of manufacture to that described above. However, the center-fill is typically an aqueous liquid or gel, which is injected into the center of the gum during processing. The center-filled gum can also be coated and can be prepared in various forms, such as in the form of a lollipop.

The chewing gum core comprises a gum base, bulk sweeteners, high intensity sweeteners, flavorants, coloring agents, sensates, and any other optional additives, including throat-soothing agents, spices, tooth-whitening agents, breath-freshening agents, vitamins, minerals, caffeine, drugs (e.g., medications, herbs, and nutritional supplements), oral care products, and a combination comprising at least one of the foregoing additives. As used herein, the terms “elastomeric portion” and “gum base” refer to water insoluble material(s) and can include, but are not limited to, elastomers, bulking agents, waxes, elastomer solvents, emulsifiers, plasticizers, fillers, and a combination comprising at least one of the foregoing materials.

Generally, the chewing gum composition comprises a water insoluble gum base portion and a water-soluble bulk portion. The gum base can vary greatly depending upon various factors such as the type of base desired, the consistency of gum desired, and the other components used in the composition to make the final chewing gum product. The gum base can be any water-insoluble gum base known in the art, and includes those gum bases utilized for chewing gums and bubble gums. As used herein, the terms “elastomeric portion” and “gum base” refer to water insoluble material(s) and can include, but are not limited to, elastomers, plasticizers, elastomer solvents, waxes, bulking agents, emulsifiers, fillers, and a combination comprising at least one of the foregoing materials.

The amount of gum base employed will vary greatly depending upon various factors such as the type of base used, the desired consistency of the chewing gum, and the other components used in the composition to make the final chewing gum core. In general, the gum base will be present in amounts of about 5% to about 60% of the chewing gum core, specifically about 25% to about 50%, more specifically about 30% to about 45%, and yet more specifically about 35% to about 40% by weight, based on the weight of the chewing gum core.

The chewing gum core generally contains an elastomer. The elastomer may be present in a gum base which may further include a fat, an emulsifier, and wax, a filler, an antioxidant, and a combination comprising at least one of the foregoing ingredients. Exemplary elastomers to be used in the chewing gum core include both natural and synthetic elastomers and rubbers, for example, substances of vegetable origin such as chicle, crown gum, nispero, rosidinha, jelutong, perillo, niger gutta, tunu, balata, gutta-percha, lechi-capsi, sorva, gutta kay, and the like. Synthetic elastomers such as butadiene-styrene copolymers, polyisobutylene, isobutylene isoprene copolymers, polyethylene, a combination comprising at least one of the foregoing elastomers, are also useful. The gum base can include a non-toxic vinyl polymer, such as polyvinyl acetate and its partial hydrolysate, polyvinyl alcohol, and a combination thereof. Additional useful polymers include: crosslinked polyvinyl pyrrolidone, polymethylmethacrylate; copolymers of lactic acid, polyhydroxyalkanoates, plasticized ethylcellulose, polyvinyl acetatephthalate and a combination comprising at least one of the foregoing polymers.

Conventional additives can be included in the gum base in effective amounts such as plasticizers or softeners to provide a variety of desirable textures and consistency properties. Because of the low molecular weight of these components, the plasticizers and softeners are able to penetrate the fundamental structure of the gum base making it plastic and less viscous. Suitable plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and a combination comprising at least one of the foregoing plasticizers and softeners. In some embodiments, the plasticizer or softener is present in amounts of up to about 30 weight percent of the gum base, specifically about 3 to about 20 weight percent of the gum base.

The chewing gum core or gum base can optionally contain conventional elastomer solvents to aid in softening the elastomer base component, for example trepanned resins such as polymers of alpha-pinene or beta-pinene, methyl, glycerol or pentaerythritol esters of rosins or modified rosins and gums, such as hydrogenated, dimerized or polymerized rosins, and combinations comprising at least one of the foregoing resins, the pentaerythritol ester of partially hydrogenated wood or gum rosin, the pentaerythritol ester of wood or gum rosin, the glycerol ester of wood rosin, the glycerol ester of partially dimerized wood or gum rosin, the glycerol ester of polymerized wood or gum rosin, the glycerol ester of tall oil rosin, the glycerol ester of wood or gum rosin, the partially hydrogenated wood or gum rosin, the partially hydrogenated methyl ester of wood or rosin, and the like. The elastomer solvent can be used in amounts of about 5% to about 75%, and specifically about 45% to about 70% by weight, based on the weight of the gum base.

Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, and the like can also be incorporated into the gum base to obtain a variety of desirable textures and consistency properties.

When a wax is present in the gum base, it softens the polymeric elastomer mixture and improves the elasticity of the gum base. The waxes employed will have a melting point below about 60° C., specifically about 45° C. to about 55° C. The low melting wax can be a paraffin wax. The wax can be present in the gum base in an amount of about 6% to about 10%, specifically about 7% to about 9.5% by weight, based on the weight of the gum base.

In addition to the low melting point waxes, waxes having a higher melting point can be used in the gum base in amounts of up to about 5% by weight of the gum base. Such high melting waxes include beeswax, vegetable wax, candelilla wax, carnauba wax, most petroleum waxes, and the like, and mixtures thereof.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate, tricalcium phosphate and a combination comprising at least one of the foregoing mineral adjuvants, which can serve as fillers and textural agents. These fillers or adjuvants can be used in the gum base in various amounts. Specifically the amount of filler, when used, will be present in an amount of greater than about 0% to about 60% by weight of the gum base, and more specifically from about 20% to about 30% by weight of the gum base.

Suitable emulsifiers include distilled monoglycerides, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate, glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, tweens, spans, stearoyl lactylates, calcium stearoyl-2-lactylate, sodium stearoyl-2-lactylate lecithin, ammonium phosphatide, sucrose esters of fatty acids, sucroglycerides, propane-1,2-diol esters of fatty acids, and a combination thereof.

A chewing gum composition (or confectionery composition) can, optionally further comprise one or more additional ingredients (or additives). Suitable additives include sweetening agents, flavor modulators and potentiators, flavorants, aroma agents, coolants, warming agents, coloring agents, breath fresheners, mouth moisteners, humectants, acidulants, buffering agents, tingling agents, oral care agents, throat care agents, medicaments, antioxidants, preservatives, and combinations thereof. Some of these additives can serve more than one purpose. For example, a sweetening agent such as sucrose, sorbitol, other sugar alcohols, and combinations thereof can also function as a bulking agent. A combination comprising at least one of the foregoing additional ingredients is often used.

In some embodiments, the chewing gum includes a sweetening agent to provide a sweet taste to the gum composition. Sweetening agents can include sugar sweeteners, sugarless sweeteners, high intensity sweeteners, or a combination of at least two of the foregoing sweetening agents.

Sugar sweeteners generally include saccharides. Suitable sugar sweeteners include monosaccharides, disaccharides and polysaccharides such as sucrose (sugar), dextrose, maltose, dextrin, xylose, ribose, glucose, mannose, galactose, fructose (levulose), lactose, invert sugar, fructo-oligo saccharide syrups, partially hydrolyzed starch, corn syrup solids, such as high fructose corn syrup, and combinations thereof.

Suitable sugarless sweeteners include sugar alcohols (or polyols) such as sorbitol, xylitol, mannitol, galactitol, maltitol, hydrogenated isomaltulose (isomalt), lactitol, erythritol, hydrogenated starch hydrolysate, and combinations thereof. Suitable hydrogenated starch hydrolysates include those disclosed in U.S. Pat. No. 4,279,931 to Verwaerde et al. and various hydrogenated glucose syrups and/or powders, which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN™, a line of commercially available products manufactured by Roquette Freres of France, and HYSTAR™, a line of commercially available products manufactured by Lonza, Inc., of Fair Lawn, N.J., USA.

A “high intensity sweetener” as used herein means agents having a sweetness at least 100 times that of sugar (sucrose) on a per weight basis, specifically at least 500 times that of sugar on a per weight basis. In some embodiments the high intensity sweetener is at least 1,000 times that of sugar on a per weight basis, more specifically at least 5,000 times that of sugar on a per weight basis. The high intensity sweetener can be selected from a wide range of materials, including water-soluble natural and artificial sweeteners, derivatives of water-soluble sweeteners, dipeptide based sweeteners, and protein based sweeteners. Any combination comprising two or more high intensity sweetener can be used. One or more of the high intensity sweeteners can further be combined with one or more of the foregoing sweeteners or sweetening agents. The high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, and combinations of the foregoing forms.

Without being limited to particular sweetening agents, representative categories and examples include (1) water-soluble sweetening agents such as dihydrochalcones, monellin, steviosides, Rebaudioside A, Rebaudioside B, Rebaudioside C, glycyrrhizin, dihydroflavenol, and sugar alcohols such as sorbitol, mannitol, maltitol, monatin, and L-aminodicarboxylic acid aminoalkenoic acid ester amides, such as those disclosed in U.S. Pat. No. 4,619,834 to Zanno et al., or a combination comprising at least one of the foregoing; (2) water-soluble artificial sweeteners such as saccharin, soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, or a combination comprising at least one of the foregoing; (3) dipeptide based sweeteners, for example the L-aspartic acid derived sweeteners such as L-aspartyl-L-phenylalanine methyl ester (Aspartame) and materials described in U.S. Pat. No. 3,492,131 to Schlatter et al., L-alpha-aspartyl-N-(2,2,4,4-tetramethyl-3-thietanyl)-D-alaninamide hydrate (Alitame), methyl esters of L-aspartyl-L-phenylglycine and L-aspartyl-L-2,5-dihydrophenyl-glycine, L-alpha-aspartyl-L-phenylglycine methyl ester, L-alpha-aspartyl-L-2,5-dihydrophenylglycine methyl ester, L-aspartyl-2,5-dihydro-L-phenylalanine; L-alpha-aspartyl-2,5-dihydrophenylalanine methyl ester, L-aspartyl-L-(1-cyclohexen)-alanine, N—(N-(3,3-dimethylbutyl)-L-alpha-aspartyl)-L-phenylalamine methyl ester (Neotame), or a combination thereof; (4) derivatives of water-soluble sweeteners, such as derivatives of steviosides, derivatives of Rebaudioside A, derivatives of Rebaudioside B, derivatives of Rebaudioside C, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include 1-chloro-1′-deoxysucrose; 4-chloro-4-deoxy-alpha-D-galactopyranosyl-alpha-D-fructofuranoside, 4-chloro-4-deoxygalactosucrose, 4-chloro-4-deoxy-alpha-D-galactopyranosyl-1-chloro-1-deoxy-beta-D-fructofuranoside, 4,1′-dichloro-4,1′-dideoxygalactosucrose; 1′,6′-dichloro-1′,6′-dideoxysucrose; 1,6-dichloro-1,6-dideoxy-β-D-fructofuranosyl-4-chloro-4-deoxy-α-D-galactopyranoside; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideox y-beta-D-fructofuranoside, or 4,6,1′,6′-tetrachloro4,6,1′,6′-tetradeoxygalacto-sucrose; 4,6,1′,6′-tetradeoxy-sucrose, or a combination thereof; (5) protein based sweeteners such as thaumaoccous danielli, thaumatin, talin, or a combination thereof; and (6) amino acid based sweeteners.

In some embodiments, the sweeteners include sorbitol, mannitol, aspartame, acesulfame potassium salt, and combinations thereof. The sweeteners can be present in a suitable amount depending upon the desired level of sweetness. In some embodiments the sweeteners are present in an amount of about 35 to about 80 weight percent of the chewing gum composition. Within the range of about 35 to about 80, the amount can be about 45 to about 75 weight percent, specifically, the amount can be about 50 to 65 weight percent.

In a chewing gum product, a sweet taste can come not only from sweetening agents but also from flavor modulators or potentiators and/or from flavorants. Flavor modulators can impart a characteristic of their own that complements or negates a characteristic of another component. For example, flavors can be compounded to have additional sweet notes by the inclusion of flavor modulators or potentiators, such as vanilla, vanillin, ethyl maltol, furfural, ethyl propionate, lactones, and combinations thereof. The flavor modulators can be used in an amount about 0.01 to about 30 weight percent of the gum composition depending on the desired intensity of the aromas used. Preferably, the content of the flavor modulators is in the range of about 0.2 to about 3 weight percent of the gum composition.

Flavor potentiators are materials that intensify, supplement, modify or enhance the taste or aroma perception of an original material without introducing a characteristic taste or aroma perception of their own. In some embodiments, flavor potentiators are designed to intensify, supplement, modify, or enhance the perception of flavor, sweetness, tartness, umami, kokumi, saltiness or a combination thereof. The flavor potentiators can be used in the amount about 0.01 to about 30 weight percent of the gum composition depending on the desired intensity of the aromas used. Preferably, the content of the flavor potentiators is in the range of about 0.2 to about 3 weight percent of the gum composition.

Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, phyllodulcin, vanilla extract, vanilla oleoresin, vanillin, sugar beet extract (alcoholic extract), sugarcane leaf essence (alcoholic extract), compounds that respond to G-protein coupled receptors (T2Rs and T1Rs), and combinations thereof. In some embodiments, sugar acids, sodium chloride, potassium chloride, sodium acid sulfate, or a combination comprising at least one of the foregoing are used. In other embodiments, glutamates such as monosodium glutamate, monopotassium glutamate, hydrolyzed vegetable protein, hydrolyzed animal protein, yeast extract, and combinations thereof are included. Further examples include adenosine monophosphate (AMP), glutathione, and nucleotides such as inosine monophosphate, disodium inosinate, xanthosine monophosphate, guanylate monophosphate, and combinations thereof. Further examples of flavor potentiator compositions that impart kokumi are also included in U.S. Pat. No. 5,679,397 to Kuroda et al.

Flavorants (also known as flavorings, flavors, or flavoring agents) that can be used include those artificial and natural flavors known in the art, for example synthetic flavor oils, natural flavoring aromatics and/or oils, oleoresins, extracts derived from plants, leaves, flowers, fruits, and the like, and combinations comprising at least one of the foregoing flavorants. Non-limiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, and combinations thereof. Specific flavorants are mints such as peppermint, spearmint, artificial vanilla, cinnamon derivatives, and various fruit flavors.

Examples of artificial, natural, and synthetic fruit flavorants include coconut, coffee, chocolate, vanilla, lemon, grapefruit, orange, lime, yazu, sudachi, menthol, licorice, caramel, honey, peanut, walnut, cashew, hazelnut, almonds, pineapple, strawberry, raspberry, blackberry, tropical fruits, cherries, cinnamon, peppermint, wintergreen, spearmint, eucalyptus, and mint, fruit essence such as from apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya, and the like, and combinations thereof.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), 2-dodecenal (citrus, mandarin), and combinations thereof.

Other potential flavors whose release profiles can be managed include a milk flavor, a butter flavor, a cheese flavor, a cream flavor, a yogurt flavor, a vanilla flavor, a tea or coffee flavor, such as a green tea flavor, a oolong tea flavor, a cocoa flavor, a chocolate flavor, a mint flavor, such as peppermint, spearmint, and Japanese mint; spicy flavors, such as asafetida, ajowan, anise, angelica, fennel, allspice, cinnamon, chamomile, mustard, cardamom, caraway, cumin, clove, pepper, coriander, sassafras, savory, Zanthoxyli Fructus, perilla, juniper berry, ginger, star anise, horseradish, thyme, a tarragon, dill, capsicum, nutmeg, basil, marjoram, rosemary, bay leaf, and wasabi; alcoholic flavors, such as wine, whisky, brandy, rum, gin, and liqueur; floral and vegetable flavors, such as onion, garlic, cabbage, carrot, celery, mushroom, tomato, and any combinations thereof. Commonly used flavorings include mints such as peppermint, menthol, spearmint, artificial vanilla, cinnamon derivatives, and various fruit flavors, whether employed individually or in admixture. Flavors can also provide breath freshening properties, particularly the mint flavors when used in combination with cooling agents. In some embodiments, the composition can further include fruit juices.

The flavoring agents can be used in many distinct physical forms. Such physical forms include liquid and/or dried form. In some embodiments, the flavoring agents can be in free (unencapsulated) forms, spray dried forms, freeze dried forms, powdered forms, beaded forms, encapsulated forms, slices, pieces, and mixtures thereof. When employed in a spray-dried form, suitable drying means such as spray-drying a liquid can be used. Alternatively, the flavoring agent can be absorbed onto water-soluble materials, such as cellulose, starch, sugar, maltodextrin, gum arabic and so forth or it can be encapsulated. In still other embodiments, the flavoring agent can be adsorbed onto silicas, zeolites, and the like. The particle size of the flavoring agents can be less than 3 millimeters, less than 2 millimeters or preferably less than 1 millimeter, calculated as the longest dimension of the particle. The natural flavoring agent can have a particle size about 3 micrometers to 2 millimeters, specifically about 4 micrometers to about 1 millimeter. The flavorants can be used in the amount about 0.01 to about 30 weight percent of the gum composition depending on the desired intensity of the aromas used. Preferably, the content of the flavorants is in the range of about 0.2 to about 3 weight percent of the gum composition.

The amount of flavor modulators, flavor potentiators, and flavorants used herein can be a matter of preference subject to such factors as the type of final chewing gum product composition, the individual flavor, the gum base employed, and the strength of flavor desired. Thus, the amount of flavorants can be varied in order to obtain the result desired in the final product and such variations are within the capabilities of those skilled in the art without the need for undue experimentation.

In some embodiments, the chewing gum contains aroma agents including natural and synthetic flavorings such as natural vegetable components, flavoring aromatics and/or oils, essential oils, essences, extracts, powders, food-grade acids, oleoresins and extracts derived from plants, leaves, flowers, fruits, and the like, and combinations thereof. The aroma agents can be in liquid or powdered form. The aroma agents can be used in the amount about 0.01 to about 30 weight percent of the gum composition depending on the desired intensity of the aromas used. Preferably, the content of the aroma agents is in the range of about 0.2 to about 3 weight percent of the gum composition.

Cooling agents, also known as coolants, are additives that provide a cooling or refreshing effect in the mouth, in the nasal cavity, or on skin. Menthyl-based coolants as used herein include menthol and menthol derivatives. Menthol (also known as 2-(2-propyl)-5-methyl-1-cyclohexanol) is available in artificial form, or naturally from sources such as peppermint oil. Menthol derivatives include menthyl ester-based and menthyl carboxamide-based cooling compounds such as menthyl carboxamide, monomenthyl succinate, dimenthyl succinate, monomenthyl methyl succinate, monomenthyl glutarate, dimenthyl glutarate, menthyl 2-pyrrolidone-5-carboxylate, monomenthyl 3-methyl maleate, menthyl acetate, menthyl lactate, dimenthyl lactate, menthyl salicylate, 2-isopropanyl-5-methylcyclohexanol, 3-L-menthoxypropane-1,2-diol, menthane, menthone, menthone ketals, menthone glycerol ketals, N-ethyl-p-menthane-3-carboxamide (WS-3), or a combination thereof. Additional menthyl-based coolants, specifically menthyl carboxamides, are described in U.S. Pat. No. 7,923,577 to Bardsley et al.

Other cooling agents that can be used in combination with or in the absence of the menthyl-based coolants include, for example 2-mercapto-cyclo-decanone, hydroxycarboxylic acids with 2 to 6 carbon atoms, xylitol, erythritol, alpha-dimethyl succinate, acyclic carboxamides such as N,2,3-trimethyl-2-isopropyl butanamide (WS-23), N-ethyl-2,2-diisopropylbutanamide (ICE 10,000), and combinations thereof. Additional cooling agents include the 1-tert-butylcyclohexanecarboxamides described in U.S. Patent Application Publication Nos. US 2011/0070171 A1 and US 2011/0070329 A1 of Kazimierski et al.

Cooling compositions comprising a primary cooling compound, a secondary cooling compound, and an ingestible non-polar solvent are described in U.S. Patent Application Publication No. US 2011/0091531 A1 of Furrer et al. The cooling agents can be present in a suitable amount depending upon the desired level of cooling intensity. In some embodiments, the cooling agents are present in an amount of about 0.01 to about 1.5 weight percent of the chewing gum composition. Within the range of about 0.01 to about 1.5 weight percent, the cooling agents can be about 0.05 to about 1.25 weight percent, specifically the cooling agents can be about 0.1 to 1 weight percent.

Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming compounds included are vanillyl alcohol n-butylether (TK-1000) supplied by Takasago Perfumery Company Limited, Tokyo, Japan, vanillyl alcohol methyl ether, vanillyl alcohol ethyl ether, vanillyl alcohol n-propyl ether, vanillyl alcohol isopropyl ether, vanillyl alcohol isobutyl ether, vanillyl alcohol n-pentyl ether, vanillyl alcohol isoamyl ether, vanillyl alcohol n-hexylether, gingerol, shogaol, paradol, zingerone, capsaicin, dihydrocapsaicin, nordihydrocapsaicin, homocapsaicin, homodihydrocapsaicin, ethanol, isopropyl alcohol, isoamyl alcohol, benzyl alcohol, glycerin, and combinations thereof. The warming agents can be present in a suitable amount depending upon the desired level of warming intensity. In some embodiments, the warming agents are present in an amount of about 0.01 to about 1.5 weight percent of the chewing gum composition. Within the range of about 0.01 to about 1.5 weight percent, the warming agents can be about 0.05 to about 1.25 weight percent, specifically the warming agents can be about 0.1 to 1 weight percent.

Coloring agents (also known as colorants or colorings) can be used in amounts effective to produce a desired color for the chewing gum. Suitable coloring agents include pigments, which can be incorporated in amounts up to about 6 weight percent by weight of the chewing gum. For example, titanium dioxide can be incorporated in amounts of about 0.1 to about 2 weight percent and specifically about 0.15 to about 1 weight percent by weight of the chewing gum. Suitable coloring agents also include natural food colors and dyes suitable for food, drug, and cosmetic applications.

Suitable colorants include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), FD&C aluminum lakes, and combinations thereof. The coloring agents can be present in a suitable amount depending upon the desired level of coloring intensity. In some embodiments, the coloring agents are present in an amount of about 0.005 to about 1.25 weight percent of the chewing gum composition. Within the range of about 0.005 to about 1 weight percent, the coloring agents can be about 0.01 to about 1 weight percent, specifically the coloring agents can be about 0.02 to 0.8 weight percent of the chewing gum composition.

Exemplary breath fresheners include zinc citrate, zinc acetate, zinc fluoride, zinc ammonium sulfate, zinc bromide, zinc iodide, zinc chloride, zinc nitrate, zinc fluorosilicate, zinc gluconate, zinc tartrate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based material, carbon-based material, enzymes such as laccase, and combinations thereof. Breath fresheners can include essential oils as well as various aldehydes and alcohols. Essential oils used as breath fresheners can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, orange, and combinations thereof. Aldehydes such as cinnamic aldehyde and salicylaldehyde can be used. Additionally, chemicals such as menthol, carvone, iso-garrigol, and anethole can function as breath fresheners. The breath fresheners can be present in a suitable amount depending upon the desired level of intensity. In some embodiments, the breath fresheners are present in an amount of about 0.01 to about 2 weight percent of the chewing gum composition. Within the range of about 0.01 to about 2 weight percent, the breath fresheners can be about 0.05 to about 1.25 weight percent; specifically, the breath fresheners can be about 0.1 to 1 weight percent.

Exemplary mouth moisteners include saliva stimulators such as acids and salts including acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and salts of the foregoing acids. Mouth moisteners can include hydrocolloid materials that hydrate and can adhere to oral surface to provide a sensation of mouth moistening. Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin, gum arabic, acacia gum, alginates, agar, carrageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Mouth moisteners can include modified natural gums such as propylene glycol alginate, carboxymethyl locust bean gum, low methoxyl pectin, or a combination thereof. Modified celluloses can be included such as microcrystalline cellulose, carboxymethylcellulose (CMC), methylcellulose (MC), hydroxypropylmethylcellulose (HPMC), hydroxypropylcellulose (MPC), or a combination thereof. The mouth moisteners can be present in a suitable amount depending upon the desired level of intensity. In some embodiments, the mouth moisteners are present in an amount of about 0.01 to about 2 weight percent of the chewing gum composition. Within the range of about 0.01 to about 2 weight percent, the mouth moisteners amount can be about 0.05 to about 1.25 weight percent; specifically, about 0.1 to 1 weight percent.

Similarly, humectants, which can provide a perception of mouth hydration, can be included. Such humectants can include glycerol, sorbitol, polyethylene glycol, erythritol, xylitol, and combinations thereof. Additionally, in some embodiments, fats can provide a perception of mouth moistening. Such fats can include medium chain triglycerides, vegetable oils, fish oils, mineral oils, and combinations thereof. The humectants can be present in a suitable amount depending upon the desired level of intensity. In some embodiments, the humectants are present in an amount of about 0.01 to about 2 weight percent of the confectionery composition. Within this range, the humectant amount can be about 0.05 to about 1.25 weight percent, specifically about 0.1 to 1 weight percent.

Suitable acidulants illustratively include acetic acid, citric acid, fumaric acid, hydrochloric acid, lactic acid and nitric acid as well as sodium citrate, sodium bicarbonate, sodium carbonate, sodium or potassium phosphate, magnesium oxide, potassium metaphosphate, sodium acetate, and combinations thereof. The acidulants can be present in a suitable amount depending upon the desired level of intensity. In some embodiments, the acidulants are present in an amount of about 0.1 to about 3 weight percent of the confectionery composition. Within this range, the acidulant amount can be about 0.5 to about 2.5 weight percent, specifically about 0.75 to 2 weight percent.

Exemplary buffering agents include sodium bicarbonate, sodium phosphate, sodium hydroxide, ammonium hydroxide, potassium hydroxide, sodium stannate, triethanolamine, citric acid, hydrochloric acid, sodium citrate, and combinations thereof. The buffering agents can be present in a suitable amount depending upon the desired level of intensity. In some embodiments, the buffering agents are present in an amount of about 0.01 to about 2 weight percent of the confectionery composition. Within this range, the buffering agent amount can be about 0.05 to about 1.25 weight percent, specifically about 0.1 to about 1 weight percent.

In some embodiments, a tingling sensation can be provided. Tingling agents include jambu, and alkylamides extracted from materials such as jambu or sanshool. Tingling agents can be present in a suitable amount depending upon the desired level of intensity. In some embodiments, the tingling agents are present in an amount of about 0.01 to about 2 weight percent of the confectionery composition. Within this range, the tingling agent amount can be about 0.05 to about 1.25 weight percent, specifically about 0.1 to 1 weight percent.

Suitable oral care agents include breath fresheners, tooth whiteners, antimicrobial agents, tooth mineralizers, tooth decay inhibitors, topical anesthetics, mucoprotectants, stain removers, oral cleaning agents, bleaching agents, desensitizing agents, dental remineralization agents, antibacterial agents, anticaries agents, plaque acid buffering agents, surfactants and anticalculus agents, and combinations thereof. Examples of such ingredients include, hydrolytic agents including proteolytic enzymes, abrasives such as hydrated silica, calcium carbonate, sodium bicarbonate and alumina, other active stain-removing components such as surface-active agents, including anionic surfactants such as sodium stearate, sodium palminate, sulfated butyl oleate, sodium oleate, salts of fumaric acid, glycerol, hydroxylated lecithin, sodium lauryl sulfate and chelators such as polyphosphates, which are typically employed as tartar control ingredients. Oral care ingredients can also include tetrasodium pyrophosphate and sodium tri-polyphosphate, sodium bicarbonate, sodium acid pyrophosphate, xylitol, sodium hexametaphosphate, and combinations thereof.

In addition, suitable oral care agents include peroxides such as carbamide peroxide, calcium peroxide, magnesium peroxide, sodium peroxide, hydrogen peroxide, and peroxydiphosphate, and combinations thereof. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples include papaine, krillase, pepsin, trypsin, lysozyme, dextranase, mutanase, glycoamylase, amylase, glucose oxidase, and combinations thereof.

Suitable oral care agents include surfactants that achieve increased prophylactic action and render the oral care ingredients more cosmetically acceptable. Surfactants used as oral care agents include detersive materials that impart to the composition detersive and foaming properties. Suitable surfactants include sodium stearate, sodium ricinoleate, sodium lauryl sulfate, water-soluble salts of higher fatty acid monoglyceride monosulfates, such as the sodium salt of the monosulfated monoglyceride of hydrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like. Examples of the last mentioned amides are N-lauroyl sarcosine, and the sodium, potassium, and ethanolammonium salts of N-lauroyl sarcosine, N-myristoyl sarcosine, and N-palmitoyl sarcosine.

In addition to surfactants, oral care ingredients can include antibacterial agents such as triclosan, chlorhexidine, zinc citrate, silver nitrate, copper, limonene, cetyl pyridinium chloride, and combinations thereof.

Anticaries agents can include fluoride ion sources such as sodium fluoride, potassium fluoride, sodium fluorosilicate, ammonium fluorosilicate, potassium fluoride, sodium monofluorophosphate, stannous fluoride, potassium stannous fluoride, sodium hexafluorostannate, stannous chlorofluoride, and combinations thereof.

Further examples of anticaries agents are included in U.S. Pat. No. 5,227,154 to Reynolds, U.S. Pat. No. 5,378,131 to Greenberg, and 6,685,916 to Holme et al. Oral care agents can be present in a suitable amount depending upon the desired level of care. In some embodiments, the oral care agents are present in an amount of about 0.01 to about 2 weight percent of the confectionery composition. Within this range, the oral care agent amount can be about 0.05 to about 1.25 weight percent, specifically about 0.1 to about 1 weight percent.

Throat care or throat-soothing ingredients include analgesics, antihistamines, anesthetics, demulcents, mucolytics, expectorants, antitussives, antiseptics, and combinations thereof. In some embodiments, throat-soothing agents include honey, propolis, aloe vera, glycerine, menthol, or a combination thereof. Throat care agents can be present in a suitable amount depending upon the desired level of care. In some embodiments, the throat care agents are present in an amount of about 0.01 to about 2 weight percent of the confectionery composition. Within this range, the throat care agent amount can be about 0.05 to about 1.25 weight percent, specifically about 0.1 to about 1 weight percent.

Medicaments can be included in the chewing gum product. Non-limiting illustrative categories and specific examples include antihistamines, decongestants (sympathomimetics), antitussives (cough suppressants), expectorants, anesthetics, analgesics, demulcents, antibacterial agents, antiviral agents, anti-inflammatories, antacids, antifungal agents, chemotherapeutics, diuretics, psychotherapeutic agents, homeopathic agents, anticholinergics, throat-soothing agents, antinauseants, cardiovascular agents, various alkaloids, laxatives, appetite suppressants, ACE-inhibitors, anti-asthmatics, anti-cholesterolemic s, anti-depressants, anti-diarrhea preparations, anti-hypertensives, anti-lipid agents, acne drugs, amino acid preparations, anti-uricemic drugs, anabolic preparations, appetite stimulants, bone metabolism regulators, contraceptives, endometriosis management agents, enzymes, erectile dysfunction therapies such as sildenafil citrate, fertility agents, gastrointestinal agents, homeopathic remedies, hormones, motion sickness treatments, muscle relaxants, osteoporosis preparations, oxytocics, parasympatholytics, parasympathomimetics, prostaglandins, respiratory agents, sedatives, smoking cessation aids such as bromocryptine or nicotine, tremor preparations, urinary tract agents, anti-ulcer agents, anti-emetics, hyper- and hypo-glycemic agents, thyroid and anti-thyroid preparations, terine relaxants, erythropoietic drugs, mucolytics, DNA and genetic modifying drugs, and nutritional supplements, including nutraceuticals, micronutrients, vitamins and co-enzymes. The pharmaceutically acceptable salts and prodrugs of the medicaments are also included unless specified otherwise. Some of these medicaments can serve more than one purpose. Combinations of the foregoing types of optional medicaments can be used. Two or more medicaments that have activity against the same or different symptoms can be used together in a combination.

Medicaments for the treatment of a cough, or a cold or flu symptom include elements, compounds or materials, alone or in combination, that have been used for, or have been shown to be useful for, the amelioration of at least one symptom commonly associated with cough, colds, or influenza. It is to be understood that a “medicament for the treatment of a cough, or a cold or flu symptom” includes medicaments that are also useful for the treatment of cold-like or flu-like symptoms arising from other sources, such as allergies, adverse environmental conditions, and the like. Cold, cold-like, flu, and flu-like symptoms as used herein include cough, coryza, nasal congestion, upper respiratory infections, allergic rhinitis, otitis, sinusitis, sneezing, and the discomfort, pain, fever and general malaise associated with colds, flu, allergies, adverse environmental conditions, and the like.

Examples of general categories of medicaments for the treatment of a cough, or a cold or flu symptom include antihistamines, decongestants (sympathomimetics), antitussives (cough suppressants), anti-inflammatories, homeopathic agents, expectorants, anesthetics, demulcents, analgesics, anticholinergics, throat-soothing agents, antibacterial agents, and antiviral agents. Some of these medicaments can serve more than one purpose. The pharmaceutically acceptable salts and prodrugs of the medicaments are also included unless specified otherwise. Two or more medicaments that have activity against the same or different symptoms of colds or coughs can be used together in a combination.

Exemplary antihistamines include azatadine, bromodiphenhydramine, brompheniramine, brompheniramine maleate, carbinoxamine, carbinoxamine maleate, cimetidine, chlorpheniramine, chlorpheniramine maleate, dexchlorpheniramine, diphenhydramine, diphenhydramine hydrochloride, doxylamine, phenindamine, pheniramine, phenyltoloxamine, pyrilamine, promethazine, triprolidine, loratadine, ranitidine, chlorcyclizine, terfenadine, clemastine fumarate, dimenhydrinate, prilamine maleate, tripelennamine hydrochloride, tripelennamine citrate, hydroxyzine pamoate, hydroxyzine hydrochloride, cyclizine lactate, cyclizine hydrochloride, meclizine hydrochloride, acrivastine, cetirizine hydrochloride, astemizole, levocabastine hydrochloride, cetirzine, and combinations thereof.

Exemplary decongestants include agents such as levopropoxyphene napsylate, noscapine, carbetapentane, caramiphen, chlophedianol, pseudoephedrine hydrochloride, phenylephrine, phenylpropanolamine, diphenhydramine, glaucine, pholcodine, benzonatate, ephedrine, ephinephrine, levodesoxyephedrine, oxymetazoline, naphazoline, propylhexedrine, xylometazoline, and combinations thereof.

Antitussives help relieve coughing. Examples of antitussives include codeine, dihydrocodeine, hydrocodone and hydromorphone, carbetapentane, caramiphen, hydrocodone bitartrate, chlorphedianol, noscarpine, dextromethorphan, and combinations thereof.

Expectorants include guaifenesin, aniseed, blood root, coltsfoot, elderflower, golden seal, grindelia, hyssop, lungwort, mullein, senega, thuja, thyme, vervain, glyceryl guaiacolate, terpin hydrate, N-acetylcysteine, bromhexine, ambroxol, domiodol, 3-iodo-1,2-propanediol and wild cherry, ammonium chloride, calcium iodide, iodinated glycerol, potassium guaiacolsulfonate, potassium iodide, sodium citrate, and combinations thereof.

Anaesthetics include etomidate, ketamine, propofol, and benodiazapines (e.g., chlordiazepoxide, diazepam, clorezepate, halazepam, flurazepam, quazepam, estazolam, triazolam, alprozolm, midazolam, temazepam, oxazepam, lorazepam), benzocaine, dyclonine, bupivacaine, etidocaine, lidocaine, mepivacaine, promoxine, prilocaine, procaine, proparcaine, ropivacaine, tetracaine, and combinations thereof. Other useful agents can include amobartital, aprobarbital, butabarbital, butalbital mephobarbital, methohexital, pentobarbital, phenobarbital, secobarbital, thiopental, paral, chloral hydrate, ethchlorvynol, clutethimide, methprylon, ethinamate, meprobamate, and combinations thereof.

Analgesics include opioids such as morphine, mepidine, dentanyl, sufentranil, alfentanil, aspirin, salicylamide, sodium salicylate, acetaminophen, ibuprofen, indomethacine, naproxen, atrin, isocome, midrin, axotal, firinal, phrenilin, ergot and ergot derivatives (wigraine, cafergot, ergostat, ergomar, dihydroergotamine), imitrex, and combinations thereof.

Anticholinergics include homatropine, atropine, scopolamine hydrogen bromide, L-hyoscyamine, L-alkaloids of belladonna, tincture of belladonna alkaloids, homatropine hydrogen bromide, homatropine methylbromide, methscopolamine, anisotropine, anisotropine with phenobarbital, clindinium, glycopyrrolate, hexocyclim, isopropamide, mepenzolate, methantheline, oxyphencyclimine, propantheline, tridihexethyl, dicyclomine, scopolamine, atropine, dicyclomine, flavoxate, ipratropium, oxybutynin, pirenzepine, tiotropium, tolterodine, tropicamide, trimethaphan, atracurium, doxacurium, mivacurium, pancuronium, tubocurarine, vecuronium, suxamethonium chloride, and combinations thereof.

Demulcents include coltsfoot, comfrey, corn silk, couchgrass, flaxseed, irish moss, lungwort, liquorice, mallow, marshmallow, mullein, oatmeal, parsley piert, slippery elm, and combinations thereof.

Antibacterial agents include those within the antibiotic classes of aminoglycosides, cephalosporins, macrolides, penicillins, quinolones, sulfonamides, and tetracyclines. Specific exemplary antibiotic agents include naficillin, oxacillin, vancomycin, clindamycin, erythromycin, trimethoprim-sulphamethoxazole, rifampin, ciprofloxacin, broad spectrum penicillin, amoxicillin, gentamicin, ceftriazoxone, cefotaxime, chloramphenicol, clavunate, sulbactam, probenecid, doxycycline, spectinomycin, cefixime, penicillin G, minocycline, β-lactamase inhibitors; meziocillin, piperacillin, aztreonam, norfloxacin, trimethoprim, ceftazidime, dapsone, neomycin, azithromycin, clarithromycin, amoxicillin, ciprofloxacin, and vancomycin.

Antiviral agents specifically or generally modulate the biological activity of viruses such as picornavirus, influenza virus, herpes viruses, herpes simplex, herpes zoster, enteroviruses, varicella and rhinovirus, which are associated with the common cold. Exemplary antiviral agents include acyclovir, trifluridine, idoxorudine, foscarnet, ganciclovir, zidovudine, dideoxycytosine, dideoxyinosine, dipyridamole, stavudine, cidofovir, famciclovir, valaciclovir, valganciclovir, acyclovir, didanosine, zalcitabine, rifimantadine, saquinavir, indinavir, ritonavir, ribavarin, nelfinavir, adefovir, nevirapine, delavirdine, efavirenz, abacavir, amantadine, emtricitabine, entecavir, tenofovir, zanamivir, oseltamivir, ICI 130,685, impulsin, pleconaril, penciclovir, vidarabine, cytokines, and combinations thereof.

Anti-inflammatories include salicylic acid derivatives including aspirin, paraminophenol derivatives including acetaminophen, indole and indene acetic acids including indomethacin, sulindac and etodalac, heteroaryl acetic acids including tolmetin diclofenac and ketorolac, aryl propionic acid derivatives including ibuprofen, naproxen, ketoprofen, fenopren, ketorlac, carprofen, oxaprozine, anthranilic acids including mefenamic acid, meclofenamic acid, and enolic acids including piroxicam, tenoxicam, phenylbutazone and oxyphenthatrazone.

Antacids include cimetidine, ranitidine, nizatidine, famotidine, omeprazole, bismuth antacids, metronidazole antacids, tetracycline antacids, clarthromycin antacids, hydroxides of aluminum, magnesium, sodium bicarbonates, calcium bicarbonate and other carbonates, silicates, phosphates, and combinations thereof.

Antifungal agents include, for example, ketoconazole, fluconazole, nystatin, itraconazole, clomitrazole, natamycin, econazole, isoconazole, oxiconazole, thiabendazole, tiaconazole, voriconazole, terbinafine, amorolfine, micfungin, amphotericin B, and combinations thereof.

Chemotherapeutics agents include cisplatin (CDDP), procarbazine, mechlorethamine, cyclophosphamide, camptothecin, ifosfamide, melphalan, chlorambucil, bisulfan, nitrosurea, dactinomycin, daunorubicin, doxorubicin, bleomycin, plicomycin, mitomycin, etoposide (VP16), tamoxifen, taxol, transplatinum, 5-fluorouracil, vincristin, vinblastin and methotrexate and analogs or derivative variants thereof, and combinations thereof.

Diuretics include but are not limited to acetazolamide, dichlorphenamide, methazolamide, furosemide, bumetanide, ethacrynic acid torseimde, azosemide, muzolimine, piretanide, tripamide, bendroflumethiazide, benzthiazide, chlorothiazide, hydrochlorothiazide, hydroflumethiazide, methyclothiazide, polythiazide, trichlormethiazide, indapamide, metolazone, quinethazone, amiloride, triamterene, sprionolactone, canrenone, potassium canrenoate, and combinations thereof.

Psychotherapeutic agents include thorazine, serentil, mellaril, millazine, tindal, permitil, prolixin, trilafon, stelazine, suprazine, taractan, navan, clozaril, haldol, halperon, loxitane, moban, orap, risperdal, alprazolam, chlordiaepoxide, clonezepam, clorezepate, diazepam, halazepam, lorazepam, oxazepam, prazepam, buspirone, elvavil, anafranil, adapin, sinequan, tofranil, surmontil, asendin, norpramin, pertofrane, ludiomil, pamelor, vivactil, prozac, luvox, paxil, zoloft, effexor, welbutrin, serzone, desyrel, nardil, parnate, eldepryl, and combinations thereof.

Appetite suppressants include benzphetamine, diethylpropion, mazindol, phendimetrazine, phentermine, hoodia, ephedra, and caffeine. Additional appetite suppressant are commercially under the following trade names: Adipex, Adipost, Bontril PDM, Bontril Slow Release, Didrex, Fastin, Ionamin, Mazanor, Melfiat, Obenix, Phendiet, Phendiet-105, Phentercot, Phentride, Plegine, Prelu-2, Pro-Fast, PT 105, Sanorex, Tenuate, Sanorex, Tenuate, Tenuate Dospan, Tepanil Ten-Tab, Teramine, Zantryl and combinations thereof.

Nutraceuticals and micronutrients include herbs and botanicals such as aloe, bilberry, bloodroot, calendula, capsicum, chamomile, cat's claw, echinacea, garlic, ginger, gingko, goldenseal, various ginseng, green tea, golden seal, guarana, kava kava, lutein, nettle, passionflower, rosemary, saw palmetto, St. John's wort, thyme, valerian, and combinations thereof. Also included are mineral supplements such as calcium, copper, iodine, iron, magnesium, manganese, molybdenum, phosphorous, zinc, selenium, and combinations thereof. Other nutraceuticals that can be added include fructo-oligosaccharides, glucosamine, grapeseed extract, cola extract, guarana, ephedra, inulin, phytosterols, phytochemicals, catechins, epicatechin, epicatechin gallate, epigallocatechin, epigallocatechin gallate, isoflavones, lecithin, lycopene, oligofructose, polyphenols, flavanoids, flavanols, flavonols, and psyllium as well as weight loss agents such as chromium picolinate and phenylpropanolamine. Vitamins and co-enzymes include water or fat-soluble vitamins such as thiamin, riboflavin, nicotinic acid, pyridoxine, pantothenic acid, biotin, folic acid, flavin, choline, inositol and paraminobenzoic acid, carnitine, vitamin C, vitamin D and its analogs, vitamin A and the carotenoids, retinoic acid, vitamin E, vitamin K, vitamin B₆, vitamin B₁₂, and combinations thereof. Combinations comprising at least one of the foregoing nutraceuticals can be used.

Specific optional, additional medicaments that can be used include caffeine, cimetidine, ranitidine, famotidine, omeprazole, dyclonine, nicotine, and combinations thereof.

The medicaments can be present in a suitable amount depending upon the suitable level of dosage for the desired purpose. In some embodiments, the medicaments are present in an amount of about 0.01 to about 2 weight percent of the confectionery composition. Within this range, the medicament amount can be about 0.05 to about 1.25 weight percent, specifically about 0.1 to about 1 weight percent.

Antioxidants include natural and artificial antioxidants like beta-carotenes, acidulants (e.g. Vitamin C), propylgallate, butylated hydroxyanisole, butylated hydroxytoluene, Vitamin E, Carnosic acid, Rosmanol, rosmaridiphenol, and combinations thereof. The antioxidants can be present in a suitable amount depending upon the desired purpose. In some embodiments, the antioxidants are present in an amount of about 0.01 to about 2 weight percent of the confectionery composition. Within the range of about 0.01 to about 2 weight percent, the antioxidant amount can be about 0.05 to about 1.25 weight percent, specifically about 0.1 to about 1 weight percent.

Preservatives include any natural and synthetic preservatives that improve shelf life of a chewing gum product. Suitable preservatives include propanoic acid, benzoic acid, and sorbic acid.

The relative amounts of each of the components of the chewing gum composition will depend on the identity of the particular component of the chewing gum composition, as well as, the desired flavor of the chewing gum composition, and are readily determined by one of ordinary skill in the art.

In some embodiments, the gum center or other confectionery base composition further comprises an oil or fat. In some embodiments, the oil or fat is selected from the group consisting of partially or fully hydrogenated vegetable oil, partially or fully hydrogenated animal fat, a glyceride, and a combination thereof. In some embodiments, the partially or fully hydrogenated oil or fat is selected from the group consisting of coconut oil, corn oil, palm kernel oil, peanut oil, soy bean oil, sesame oil, cottonseed oil, cocoa butter, milk fat, beef tallow, and lard. In some embodiments, the oil or fat is partially or fully hydrogenated coconut oil. In some embodiments, the oil or fat has an iodine value of 10 or less. In some embodiments, the oil or fat has an iodine value of about 45 to about 55. In some embodiments, the oil or fat has a melting point of about 35 to about 40° C.

As used herein, “w/w” refers to “weight to weight”. In some embodiments, the fat is present in an amount of about 2.0 to about 6.0% w/w of the confectionery composition. In some embodiments, the fat is present in an amount of about 3.0 to about 5.0% w/w of the confectionery composition. The fat can be cocoa butter, cocoa butter substitute, cocoa butter replacers, cocoa butter improvers or cocoa butter equivalents, among others. Cocoa butter substitute is a lauric fat obtained from the kernel of the fruit of palm trees obtained by fractionation and/or hydrogenation of palm kernel oil. It comprises about 55% lauric acid, 20% myristic acid and 7% oleic acid, cocoa butter substitutes cannot be mixed with cocoa butter. The cocoa butter equivalents are vegetable fats with similar chemical and physical characteristics to cocoa butter, which are obtained by blending different fractions of other fats or by inter-esterification, and can be used interchangeably with cocoa butter in any recipe. The cocoa butter replacers are formed by non lauric vegetable fats which may be mixed with cocoa butter but only in limited proportions: they have similar physical, but not chemical characteristics to cocoa butter. Cocoa butter replacers can be used in recipes partially based on cocoa mass or cocoa butter. Cocoa butter improvers are harder, cocoa butter equivalents which are not only equivalent in their compatibility but also improve the hardness of some of the softer qualities of cocoa butter.

The relative amounts of each component of the gum core or other confectionery base composition will depend on the desired final amounts in the product, the presence of any optional additives, or the use of a diluent. The relative amounts can be readily determined by one of ordinary skill in the art without undue experimentation, using the below guidelines.

The chewing gum cores can be prepared using standard techniques and equipment. In one exemplary process, a gum base is heated to a temperature sufficiently high to soften the base without adversely affecting the physical and chemical makeup of the base, which will vary depending upon the composition of the gum base used, and is readily determined by those skilled in the art without undue experimentation. For example, the gum base can be conventionally melted to about 60° C. to about 160° C., or melted to about 150° C. to about 175° C., for a period of time sufficient to render the base molten, e.g., about thirty minutes, just prior to being admixed incrementally with the remaining ingredients of the base such as the plasticizer, fillers, the bulking agent or sweeteners, the softener and coloring agents to plasticize the blend as well as to modulate the hardness, viscoelasticity and formability of the base, and the flavor enhancing composition (as a concentrate with other additives or separately). Mixing is continued until a uniform mixture of the gum composition is obtained. Thereafter the gum composition mixture can be formed into a desired shape.

The chewing gum cores can be provided in a variety of different forms, such as, for example, slabs, pellets, sticks cylinders, chunks ropes, strings, balls, cubes, candy gums, center-fill gums, multi-region gums, deposited gums and compressed gums.

The chewing gum core can be prepared using a batch method, a continuous method or a combination thereof. As used herein, “a continuous mixer” is processing equipment in which the various ingredients used to prepare a composition are fed substantially continuously into the device whilst those ingredients are being mixed and removed or ejected from the mixing apparatus. For example, in a continuous mixing extruder, some ingredients are substantially continuously introduced through various feed ports while others are introduced downstream, all the while the screws, blades or other mixing elements continuing to convey the mixture through the apparatus, all the while mixing the same. At a downstream portion of the extruder, the wholly or partly combined mass is ejected from the extruder by the force of the mass continually being conveyed and/or facilitated by an external pump.

The multi-region confectionery composition can be of particular utility in the preparation of dosage delivery systems with confectionery components, including compressed tablets such as mints, hard boiled candies, chocolates, chocolate-containing products, nutrient bars, nougats, gels, centerfill confections, fondants, panning goods, consumable thin films, and other confectionery forms. Confectioneries have been classified as either “hard” or “soft” confectionery items. In one embodiment the flavor-enhancing composition is used in a confectionery form, in particular a hard confectionery such as a lozenge. In another embodiment, the flavor-enhancing composition is used in a chewing gum. The flavor enhancing compositions can be incorporated into an otherwise conventional hard or soft confectionery using standard techniques and equipment known to those of ordinary skill in the art.

In general, a hard confectionery has a base composed of a mixture of sugar or sugar alcohols and other carbohydrate bulking agents, and has an amorphous or glassy form. This form is considered a solid syrup of sugars or sugar alcohols generally having about 0.5 to about 1.5 weight percent moisture, based on the weight of the confectionery. Such materials normally contain up to about 92 weight percent corn syrup, up to about 55 weight percent sugar and about 0.1 to about 5 weight percent water, based on the weight of the confectionery base. The syrup component can be prepared from high fructose corn syrup, but can include other materials.

In some embodiments, the hard confectioneries are prepared using conventional methods and equipment, such as fire cookers, vacuum cookers, or scraped-surface cookers (also referred to as high speed atmospheric cookers). When using a fire cooker, the desired quantity of carbohydrate bulking agent is dissolved in water by heating the agent in a kettle until the bulking agent dissolves. Additional bulking agent can then be added and the cooking continued until a final temperature of, for example, 145 to 156 degrees Celsius is achieved. The batch is then cooled and worked as a plastic-like mass to incorporate additives separately or in the form of one or more concentrates.

Compressed tablet confectionery forms, in contrast, are formed into structures under pressure. These confectionaries generally contain sugars or sugar alcohols in amounts up to about 95 weight percent of the composition, tablet excipients such as binders and lubricants, as well as additives.

The solid, oral dosage forms can be prepared by methods known in the art of hard confectionaries, for example, hard-boiled confectionaries. Particular apparatus for making the oral dosage form includes cooking and mixing apparatus known in the confectionery manufacturing arts, and appropriate apparatus will be apparent to the skilled artisan.

Methods known in the art of making hard confectionaries include those utilizing fire cookers, vacuum cookers, and scraped-surface cookers, also known as high speed atmospheric cookers.

The process of preparation can be adapted by those skilled in the art to provide solid dosage forms having a desired configuration, including single-layer, multi-layer having two or more layers (for example, three layers), and forms having a center core.

The preparation of soft confectionery such as nougat, involves methods, such as the combination of two primary components, namely (1) a high boiling syrup such as a corn syrup, hydrogenated starch hydrolysate or the like, and (2) a relatively light textured frappe. The high boiling syrup, or “bob syrup” of the soft confectionery is relatively viscous and has a density that is greater than the frappe component, and frequently contains a substantial amount of carbohydrate bulking agent such as a hydrogenated starch hydrolysate. The frappe is generally prepared from egg albumin, gelatin, vegetable proteins including soy-derived compounds, sugarless milk-derived compounds including milk proteins, and combinations thereof. The frappe is relatively light and can range in density of about 0.5 to about 0.7 grams/cubic centimeters. Conventionally, the final nougat composition is prepared by the addition of the bob syrup into the frappe during agitation, to form the basic nougat mixture. In one method the frappe is prepared first and thereafter the bob syrup is slowly added under agitation at a suitable temperature, for example at a temperature of at least about 65 degrees Celsius, and specifically at a temperature of at least about 100 degrees Celsius. After formation of a uniform mixture, the mixture is cooled, for example to below about 80 degrees Celsius, at which point additional ingredients such as flavoring, additional carbohydrate bulking agents, coloring agents, preservatives, medicaments, and the like can be added with further mixing. The mixture is then formed into suitable confectionery shapes.

Some embodiments can include a method for preparing the gum compositions, including both chewing gum and bubble gum compositions. The chewing gum compositions can be prepared using standard techniques and equipment known to those skilled in the art. The apparatus useful in accordance with some embodiments comprises mixing and heating apparatus well known in the chewing gum manufacturing arts, and therefore the selection of the specific apparatus will be apparent to the artisan.

### Intermediate Coatings

This intermediate coating can be hard or crunchy. In some embodiments, the intermediate coating includes sorbitol, maltitol, xylitol, isomalt, or another crystallizable polyol; sucrose can also be used. Flavorants can also be added to yield unique product characteristics. In some embodiments, gum pieces can be coated with an at least aqueous coating composition, which can be applied by any method known in the art. The coating composition can be present in an amount of about 25 to about 35 weight percent of the total gum piece.

These intermediate coatings, if present, can include several opaque layers, such that the chewing gum composition is not visible through the coating itself, which can optionally be covered with a further one or more transparent layers for aesthetic, textural and protective purposes. This intermediate coating can be applied by successive applications of a coating solution, with drying in between each coat. As the coating dries it usually becomes opaque and is usually white, though other colorants can be added.

These intermediate coatings can be applied to the surface or surfaces of the chewing gum core. Then the colored wax coating composition may be applied to the desired surface of the confectionery by any means desired, including panning, dipping, spraying, rolling, brushing, and a combination thereof. Optionally, after the step of applying the colored wax coating composition has been completed, a further step of applying pressure to the coated surface may be used.

### Other Confectionery Cores

In other embodiments, the particulate coating composition may also be applied to confectionery cores other than chewing gum. In some embodiments, the confectionery core is a chewable confectionery including gummy candy or “gummi” confectionery. The chewable confectionery may include soft candies such as, but not limited to, gum drops, licorice, fruit snacks, starch based jellies, gelatin based jellies, pectin based jellies, carageenan based jellies, agar based jellies, konjac based jellies, starch candy, nougat, toffee, taffy, marshmallow, fondant, fudge, chocolate, marzipan, and jelly beans. The chewable confectionery may also include harder candies such as, but not limited to, compressed tablets, hard boiled candy, nut brittles, pastilles, pralines, dragees, and lozenges. The base of the chewable confectionery may be a sugar/glucose syrup combination or a polyol/polyol syrup combination and a gelatinizing agent, the latter of which may be gelatin, agar, gum arabic, maltodextrin, pectin, modified starches and combinations thereof. Various other gums (also referred to as hydrocolloids) may also be used. The gelatinizing material may be desirably dissolved in water or otherwise hydrated prior to mixing with the sugar/glucose syrup combination. If a hydrocolloid such as pectin is used as the gelatinizing agent, then the pectin is desirably dry mixed with a portion of the sugar or bulk sweetener prior to addition of the dry mixture to water.

In general, preparation of a hard candy involves: mixing and heating, forming a melt a sugar polyol and optionally, other sugar polyols and/or a diluent such as water; cooking the melt; removing excess moisture from the melt; cooling the melt with mixing until the melt is a plastic-like, workable mass; while the melt is a plastic-like mass, incorporating optional ingredients; and forming the plastic-like mixture into a desired size and shape.

Methods known in the art of making hard confectionaries include those utilizing fire cookers, vacuum cookers, and scraped-surface cookers (aka high speed atmospheric cookers). In a suitable example of a method utilizing fire cookers, the desired quantity of the sugar polyol is dissolved in water by heating in a kettle until dissolved. Additional optional sugar polyols can be added and cooking continued until a final temperature of about 145-165° C. is achieved. The mix is then cooled, worked as a plastic-like mass, and admixed optional ingredients such as flavors, colorants, high-intensity sweeteners, and the like.

A suitable example of a method utilizing vacuum cookers, the sugar polyol components are boiled at a temperature of about 125-132° C., vacuum is applied and additional water is boiled off without extra heating. When cooking is complete, the mass is a semi-solid having a plastic-like consistency. Optional conventional additives are admixed into the mass at this point by conventional methods.

In a suitable example of a method using scraped-surface cookers, a film of a mixture of the sugar polyol components is spread on a heat exchange surface and heated to about 165-170° C. within a few minutes. The composition is then rapidly cooled to about 100-120° C. and worked as a plastic-like mass, mixing in any optional conventional additives.

In the foregoing methods, the cooking temperature should be sufficiently high to drive water from the mix. Where vacuum is employed, lower temperatures can typically be used. In the foregoing methods, the additive(s) are specifically mixed for a time effective to provide a uniform distribution of the materials, for example about 4 to about 10 minutes. Once the composition has been properly tempered, it can be cut into workable portions or otherwise formed into desired shapes and sizes using forming techniques such as are known in the art.

The foregoing and other embodiments are further illustrated by the following examples, which are not intended to limit the effective scope of the claims. All parts and percentages in the examples and throughout the specification and claims are by weight of the final composition unless otherwise specified.

### EXAMPLES

### Example 1

### Preparation of Gum Core Pellets

A conventional gum core was produced from the following ingredients (percentages):

| | |
|---|---|
| Gum Base | (29.16667% by weight) |
| Calcium Carbonate | (9.125%) |
| Lecithin | (0.35%) |
| Sorbitol | (47.3662%) |
| Plasticizers | (2.5%) |
| Mannitol | (5.0%) |
| Flavor Blend | (3.2690%) |
| Sweeteners | (3.2232%) |
| Total | (100% by weight) |

This conventional gum core was produced by melting the gum base in a container to 75 to 90 degrees C. with stirring. The calcium carbonate filler was then added to the molten gum base, mixed well and transferred to a jacketed gum mixing kettle with warm and cold water circulation to keep the gum temperate at 40 to 45 degrees C., followed by adding the sorbitol, plasticizers and mannitol and mixing to form a homogeneous mass.

The flavor blend was then added to that mixture and stirring continued for 3 minutes. Then the sweeteners were added and mixing was continued for 3 minutes.

The gum core pellets were then form by passing the final gum mixture through a pellet forming apparatus, thereby forming individual gum core pellets. These pellets were allowed to cool to room temperature. Each pellet weighed about 1.0 grams each.

### Example 2

### Preparation of Polyol Coating Solution and Accompanying Flavor Blend and Sweetener

A polyol coating solution was formed by mixing together the following ingredients (percentages):

| | |
|---|---|
| Water | (28.6025% by weight) |
| Maltitol | (66.4300%) |
| Gum Acacia | (4.5975%) |
| Titanium dioxide | (0.3700%) |
| Total | (100.00% by weight) |

A flavor blend was formed by mixing together the following ingredients (percentages):

| | |
|---|---|
| Wintergreen 3 Mint Blend | (34.6616% by weight) |
| Vanilla | (38.3953%) |
| Vanilla NF | (4.2362%) |
| Menthol | (15.0063%) |
| WS-3 Cooling Agent | (7.7006%) |
| Total | (100.00% by weight) |

This flavor blend was used to accompany the polyol coating solution in coating the gum core pieces. Milled potassium acesulfame was also used to accompany the polyol coating solution in coating the gum core pieces.

### Example 3

### Coating the Gum Core Pellets with the Polyol Coating Solution

One kilogram of gum core pellets (about 1000 pellets) made by Example 1 were introduced into a regular gum polishing pan made by F. J. Stokes Machine Company that was equipped with an stainless steel internal surface and holes in that surface to allow air used for drying to escape the panning area. The pan speed was 42 RPM and the air temperature was at about 28 to 30 degrees C. A small amount of the polyol coating solution of Example 2 was added to the pan and rolled for a few minutes until that solution completely covered the gum core pellets. Then a blast of dry air was introduced into the pan from air ducts provided to remove the moisture of the polyol syrup and dry the pellets. This solution addition followed by air drying was repeated about 60 to about 65 times over a period of about 5 to 6 hours until the dried coated pellets weighed 1.5 kilograms (or 1.5 gram per pellet). During this panning process, small amounts of the milled potassium acesulfame and the flavor blend were added along with the coating solution to the pan. Specifically, upon adding 25% by weight of the coating solution to the pan, 0.7 grams of the milled potassium acesulfame was added to the pan and allowed to coat the pellets. After adding 60% by weight of the coating solution to the polishing pan, 3.8 grams of the flavor blend shown in Example 2 was added to the pan and allowed to coat the pellets. After adding 70% by weight of the coating solution to the polishing pan, another 3.8 grams of the flavor blend shown in Example 2 was added to the pan. After adding 80% by weight of the coating solution to the polishing pan, another 3.8 grams of the flavor blend shown in Example 2 was added to the pan. These polyol-coated pellets were then removed from this stainless steel-lined polishing pan and were ready for the color wax coating to be applied.

### Example 4

### Preparation of Green Sour Apple Lake Colored Wax

The following ingredients (and their percentages) were combined together to make a colored wax:

| | |
|---|---|
| Candelilla Wax | (75.0% by weight) |
| Sour Apple Green Lake 09225 in water | (16.67%) |
| (1:9 lake to water weight ratio) | |
| Glycerol Monostearate | (4.17%) |
| Lecithin | (4.17%) |
| Total | (100% by weight) |

The candelilla wax was melted at about 70 to 80 degrees C. and then the lake/water mixture, glycerol monostearate and lecithin were mixed into the melted wax using a propeller until a homogenous mass was obtained. The mass was allowed to cool and resulting colored solid wax as cut using a knife into sizes having lengths of 0.5 to 3.0 mm; widths of 0.1 to 2.0 mm; and thickness of 0.5 to 1 mm.

### Example 5

### Preparation of Yellow 6 Lake Colored Wax

The following ingredients (and their percentages) were combined together to make a colored wax:

| | |
|---|---|
| Candelilla Wax | (75.0% by weight) |
| FD&C Yellow 6 Alum Lake 17-19%, 38900720 | (16.67%) |
| in water (1:9 lake to water weight ratio) | |
| Glycerol Monostearate | (4.17%) |
| Lecithin | (4.17%) |
| Total | (100% by weight) |

The candelilla wax was melted at about 70 to 80 degrees C. and then the lake/water mixture, glycerol monostearate and lecithin were mixed into the melted wax using a propeller until a homogenous mass was obtained. The mass was allowed to cool and resulting colored solid wax was cut using a knife into sizes having lengths of 0.5 to 3.0 mm; widths of 0.1 to 2.0 mm; and thickness of 0.5 to 1 mm.

### Example 6

### Preparation of Yellow 5 Lake Colored Wax

The following ingredients (and their percentages) were combined together to make a colored wax:

| | |
|---|---|
| Candelilla Wax | (75.0% by weight) |
| FD&C Yellow 5 Alum Lake 14-16%, 38900359 | (16.67%) |
| in water (1:9 lake to water weight ratio) | |
| Glycerol Monostearate | (4.17%) |
| Lecithin | (4.17%) |
| Total | (100% by weight) |

The candelilla wax was melted at about 70 to 80 degrees C. and then the lake/water mixture, glycerol monostearate and lecithin were mixed into the melted wax using a propeller until a homogenous mass was obtained. The mass was allowed to cool and resulting colored solid wax was cut using a knife into sizes having lengths of 0.5 to 3.0 mm; widths of 0.1 to 2.0 mm; and thickness of 0.5 to 1 mm.

### Example 7

### Preparation of Blue Opatinit G-10529 Lake Colored Wax in Glycerin

The following ingredients (and their percentages) were combined together to make a colored wax:

| | |
|---|---|
| Candelilla Wax | (75.0% by weight) |
| Blue Opatinit G-10529 Lake in glycerin | (16.67%) |
| (about 1:7 lake to glycerin weight ratio) | |
| Glycerol Monostearate | (4.17%) |
| Lecithin | (4.17%) |
| Total | (100% by weight) |

The candelilla wax was melted at about 70 to 80 degrees C. and then the lake, glycerol monostearate and lecithin were mixed into the melted wax using a propeller until a homogenous mass was obtained. The mass was allowed to cool and resulting colored solid wax was cut using a knife into sizes having lengths of 0.5 to 3.0 mm; widths of 0.1 to 2.0 mm; and thickness of 0.5 to 1 mm.

### Example 8

### Preparation of Red 40 Lake Colored Wax

The following ingredients (and their percentages) were combined together to make a colored wax:

| | |
|---|---|
| Candelilla Wax | (75.0% by weight) |
| FD&C Red 40 Alum Lake, 38900358 in water | (16.67%) |
| (1:9 lake to water weight ratio) | |
| Glycerol Monostearate | (4.17%) |
| Lecithin | (4.17%) |
| Total | (100% by weight) |

The candelilla wax was melted at about 70 to 80 degrees C. and then the lake/water mixture, glycerol monostearate and lecithin were mixed into the melted wax using a propeller until a homogenous mass was obtained. The mass was allowed to cool and resulting colored solid wax was cut using a knife into sizes having lengths of 0.5 to 3.0 mm; widths of 0.1 to 2.0 mm; and thickness of 0.5 to 1 mm.

### Example 9

### Preparation of Sour Apple Green Lake Colored Wax

The following ingredients (and their percentages) were combined together to make a colored wax:

| | |
|---|---|
| Candelilla Wax | (75.0% by weight) |
| Sour Apple Green Lake 09225 in water | (16.67%) |
| (1:9 lake to water weight ratio) | |
| Glycerol Monostearate | (4.17%) |
| Lecithin | (4.17%) |
| Total | (100% by weight) |

The candelilla wax was melted at about 70 to 80 degrees C. and then the lake/water mixture, glycerol monostearate and lecithin were mixed into the melted wax using a propeller until a homogenous mass was obtained. The mass was allowed to cool and resulting colored solid wax was cut using a knife into sizes having lengths of 0.5 to 3.0 mm; widths of 0.1 to 2.0 mm; and thickness of 0.5 to 1 mm.

### Example 10

### Preparation of Blue 1 Dye Colored Wax

The following ingredients (and their percentages) were combined together to make a colored wax:

| | |
|---|---|
| Candelilla Wax | (75.0% by weight) |
| FD&C Blue #1 powder dye, 05601 in water | (16.67%) |
| (1:9 lake to water weight ratio) | |
| Glycerol Monostearate | (4.17%) |
| Lecithin | (4.17%) |
| Total | (100% by weight) |

The candelilla wax was melted at about 70 to 80 degrees C. and then the lake/water mixture, glycerol monostearate and lecithin were mixed into the melted wax using a propeller until a homogenous mass was obtained. The mass was allowed to cool and resulting colored solid wax was cut using a knife into sizes having lengths of 0.5 to 3.0 mm; widths of 0.1 to 2.0 mm; and thickness of 0.5 to 1 mm.

### Example 11

### Coating a Mixture of Green Sour Apple Lake Colored Wax, Yellow 6 Lake Colored Wax and Yellow 5 Lake Colored Wax onto the Polyol-Coated Gum Cores

1.5 kilograms of polyol-coated gum core pellets (about 1000 pellets) made by Example 3 were introduced into a regular gum polishing pan made by F. J. Stokes Machine Company that was equipped with an canvas internal surface. The pan speed was 42 RPM. 1.5 grams of Green Sour Apple Lake Colored Wax cut pieces were added to the coating pan and polishing was allowed to continue for 0.5 hours until the green colored wax pieces adhered on the gum pellets. Then 1.5 grams of Yellow 6 Lake Colored Wax cut pieces were added to the coating pan and polishing was allowed to continue for 0.5 hours until the yellow orange wax pieces adhered onto the pellets. Then 1.5 grams of Yellow 5 Lake Colored Wax were added to the coating pan and polishing was allowed to continue for 0.5 hours until the yellow colored wax pieces adhered onto the pellets. The resulting coated gum cores have a continuous wax coating with green, orange and yellow speckles. After the polishing was complete, any residual colored wax was screened out from the colored wax coated gum cores.

### Example 12

### Coating a Mixture of Blue Opatinit G-10529 Lake Colored Wax, Red 40 Lake Colored Wax and Green Sour Apple Colored Wax onto the Polyol-Coated Gum Cores

1.5 kilograms of polyol-coated gum core pellets (about 1000 pellets) made by Example 3 were introduced into a regular gum polishing pan made by F. J. Stokes Machine Company that was equipped with an canvas internal surface. The pan speed was 42 RPM. 1.5 grams Blue Opatinit G-10529 Lake Colored Wax cut pieces was added to the coating pan and polishing was allowed to continue for 1.5 hours. The result was a wax coating with bright blue speckles. Then 1.5 grams of Red 40 Lake Colored Wax cut pieces were added to the coating pan and polishing was allowed to continue for 0.5 hours. The result was a wax coating with bright blue and red speckles. Then 1.5 grams of Green Sour Apple Colored Wax cut pieces were added to the coating pan and polishing was allowed to continue for 0.5 hours. The result was a wax coating with bright blue, red and green speckles. After the polishing was complete, any residual colored wax was screened out from the colored wax coated gum cores.

### Example 13

### Coating a Mixture of Sun Apple Green Lake Colored Wax and Red 40 Lake Colored Wax onto the Polyol-Coated Gum Cores

1.5 kilograms of polyol-coated gum core pellets (about 1000 pellets) made by Example 3 were introduced into a regular gum polishing pan made by F. J. Stokes Machine Company that was equipped with an canvas internal surface. The pan speed was 42 RPM. 1.5 grams of the Sour Apple Green Lake Colored Wax cut pieces were added to the coating pan and polishing was allowed to continue for 1.0 hours. The result was a wax coating with numerous fine green speckles. Then 1.5 grams of the Red 40 Lake Colored Wax cut pieces were added to the coating pan and polishing was allowed to continue for 0.5 hours. The result was a wax coating with many green speckles and fewer red speckles. After the polishing was complete, any residual colored wax was screened out from the colored wax coated gum cores.

### Example 14

### Coating Yellow 5 Lake Colored Wax onto the Polyol-Coated Gum Cores

1.5 kilograms of polyol-coated gum core pellets (about 1000 pellets) made by Example 3 were introduced into a regular gum polishing pan made by F. J. Stokes Machine Company that was equipped with an canvas internal surface. The pan speed was 42 RPM. 1.5 grams of Yellow 5 Lake Colored Wax cut pieces were added to the coating pan and polishing was allowed to continue for 0.5 hours. The result was a wax coating with a few brighter yellow speckles. After the polishing was complete, any residual colored wax was screened out from the colored wax coated gum cores.

### Example 15

### Coating Blue 1 Dye Colored Wax onto the Polyol-Coated Gum Cores

1.5 kilograms of polyol-coated gum core pellets (about 1000 pellets) made by Example 3 were introduced into a regular gum polishing pan made by F. J. Stokes Machine Company that was equipped with an canvas internal surface. The pan speed was 42 RPM. 1.5 grams of Blue 1 Dye Colored Wax were added to the coating pan and polishing was allowed to continue for 0.5 hours. The result was a wax coating with bright blue speckles. After the polishing was complete, any residual colored wax was screened out from the colored wax coated gum cores.

### Embodiment 1

A colored wax composition comprising a multiplicity of colored wax particles comprising at least one wax, at least one colorant and at least one emulsifier, wherein the colored wax particles are made by heating the at least one wax, the at least one colorant and the at least one emulsifier together, solidifying the heated colored wax composition and then forming particles from the solidified colored wax composition, the resultant colored wax particles having an average particle size of at least 200 microns and are capable of forming speckles in a confectionery product.

### Embodiment 2

The colored wax composition of embodiment 1 wherein the at least one wax is selected from the group consisting of carnauba wax, beeswax, candelilla wax, spermaceti wax and combinations thereof.

### Embodiment 3

The colored wax composition of embodiments 1 or 2 wherein the at least one colorant is at least one lake.

### Embodiment 4

The colored wax composition of embodiments 1 or 2 wherein the at least one colorant is at least one dye.

### Embodiment 5

The colored wax composition of embodiments 1 to 4 wherein the at least one emulsifier is a mixture of lecithin and glycerol monostearate, wherein the weight ratio of the lecithin to glycerol monostearate is from about 1:10 to about 10:1.

### Embodiment 6

The colored wax composition of embodiments 1 to 5 wherein the average particle size of the at least one wax is from about 400 microns to about 1000 microns.

### Embodiment 7

A multi-region confectionery composition comprising: a first region comprising a confectionery base; and a second region at least partially surrounding the first region, the second region comprising a multiplicity of colored wax particles comprising at least one wax, at least one colorant and at least one emulsifier, wherein the colored wax particles are made by heating the at least one wax, the at least one colorant and the at least one emulsifier together, solidifying the heated colored wax composition and then forming particles from the solidified colored wax composition, the resultant colored wax particles having an average particle size of at least 200 microns and are capable of forming speckles in the multi-region confectionery composition.

### Embodiment 8

The multi-region confectionery composition of embodiment 7 wherein the at least one wax is selected from the group consisting of carnauba wax, beeswax, candelilla wax, spermaceti wax and combinations thereof.

### Embodiment 9

The multi-region confectionery composition of embodiments 7 or 8 wherein the at least one colorant is at least one lake.

### Embodiment 10

The multi-region confectionery composition of embodiments 7 or 8 wherein the at least one colorant is at least one dye.

### Embodiment 11

The multi-region confectionery composition of embodiments 7 to 10 wherein the at least one emulsifier is a mixture of lecithin and glycerol monostearate, wherein the weight ratio of the lecithin to glycerol monostearate is from about 1:10 to about 10:1.

### Embodiment 12

The multi-region confectionery composition of embodiments 7 to 11 wherein the average particle size of the at least one wax is from about 400 microns to about 1000 microns.

### Embodiment 13

The multi-region confectionery composition of embodiments 7 to 12 wherein a first region is a gum center and the multi-region confectionery composition is a chewing gum composition.

### Embodiment 14

The multi-region confectionery composition of embodiment 13 wherein a third region is positioned between the first region and the second region, said third region comprises at least one polyol coating.

### Embodiment 15

The multi-region confectionery composition of embodiment 14 wherein the polyol coating comprises a sugarless sweetener selected from the group consisting of sorbitol, mannitol, isomalt, xylitol, maltitol, erythritol, lactitol and combinations thereof.

### Embodiment 16

The multi-region confectionery composition of embodiments 14 or 15 wherein the amount of polyol coating coated onto the first region is from about 10% to 100% by weight of the first region.

### Embodiment 17

The multi-region confectionery composition of embodiments 7 to 15 wherein the amount of colored wax coating composition is from about 0.005% to 1.0% by weight of the multi-region confectionery composition.

### Embodiment 18

A method of making a speckled colored coated confectionery composition comprising the steps of: (a) providing a confectionery base having an outer surface; and (b) applying a colored wax composition to at least a portion of the outer surface of the confectionery base; the colored wax composition comprising a multiplicity of colored wax particles comprising at least one wax, at least one colorant and at least one emulsifier, wherein the colored wax particles are made by heating the at least one wax, the at least one colorant and the at least one emulsifier together, solidifying the heated colored wax composition and then forming particles from the solidified colored wax composition, the resultant colored wax particles having an average particle size of at least 200 microns and are capable of forming speckles in the confectionery product.

### Embodiment 19

The method of embodiment 18 wherein the at least one wax is selected from the group consisting of carnauba wax, beeswax, candelilla wax, spermaceti wax and combinations thereof.

### Embodiment 20

The method of embodiments 18 or 19 wherein the at least one colorant is at least one lake.

### Embodiment 21

The method of embodiments 18 or 19 wherein the at least one colorant is at least one dye.

### Embodiment 22

The method of embodiments 18 to 21 wherein the at least one emulsifier is a mixture of lecithin and glycerol monostearate, wherein the weight ratio of the lecithin to glycerol monostearate is from about 1:10 to about 10:1.

### Embodiment 23

The method of embodiments 18 to 22 wherein the average particle size of the at least one wax is from about 400 microns to about 1000 microns.

### Embodiment 24

The method of embodiments 18 to 23 wherein the confectionery base is a gum center and the confectionery composition is a chewing gum composition.

### Embodiment 25

The method of embodiment 24 wherein a third region is positioned between the confectionery base and the colored wax composition, said third region comprises at least one polyol coating.

### Embodiment 26

The method of embodiment 25 wherein the polyol coating comprises a sugarless sweetener selected from the group consisting of sorbitol, mannitol, isomalt, xylitol, maltitol, erythritol, lactitol and combinations thereof.

### Embodiment 27

The method of embodiments 25 or 26 wherein the amount of polyol coating coated onto the confectionery base is from about 10% to 100% by weight of the confectionery base.

### Embodiment 28

The method of embodiments 18 to 27 wherein the amount of colored wax composition is from about 0.005% to 1.0% by weight of the confectionery composition.

### Embodiment 29

A colored wax composition comprising: a solidified liquid mixture of at least one liquid carrier, at least one wax, at least one colorant and at least one emulsifier and is capable of forming colored wax speckles in a confectionery product, wherein the mixture comprises (a) about 2% to about 30% by weight liquid carrier; (b) about 50% to about 95% of the at least one wax; (c) about 0.1% to about 3% by weight of the at least one colorant; and (d) about 1% to about 20% by weight of the at least one emulsifier.

### Embodiment 30

The colored wax composition of embodiment 29 wherein the liquid carrier is water.

### Embodiment 31

The colored wax composition of embodiment 29 wherein the liquid carrier is glycerol.

### Embodiment 32

The colored wax composition of embodiments 28 to 31 wherein the at least one wax is selected from the group consisting of carnauba wax, beeswax, candelilla wax, spermaceti wax and combinations thereof.

### Embodiment 33

The colored wax composition of embodiments 29 to 32 wherein the at least one colorant is at least one lake.

### Embodiment 34

The colored wax composition of embodiments 29 to 32 wherein the at least one colorant is at least one dye.

### Embodiment 35

The colored wax composition of embodiments 29 to 34 wherein the at least one emulsifier is a mixture of lecithin and glycerol monostearate, wherein the weight ratio of the lecithin to glycerol monostearate is from about 1:10 to about 10:1.

### Embodiment 36

The colored wax composition of embodiments 29 to 35 wherein the colored wax composition is made from particles having an average particle size of about 200 microns to about 1000 microns.

### Embodiment 37

The colored wax composition of embodiments 32 to 36 wherein the aqueous mixture comprises (a) about 3% to about 20% by weight water; (b) about 55% to about 90% of the at least one wax; (c) about 0.3% to about 2% by weight of the at least one colorant; and (d) about 2% to about 10% by weight of the at least one emulsifier.

### Embodiment 38

A multi-region confectionery composition comprising:

a first region comprising a confectionery base; and a second region at least partially surrounding the first region, the second region comprising a colored wax composition, wherein the colored wax composition is a solidified liquid mixture of at least one liquid carrier, at least one wax, at least one colorant and at least one emulsifier and is capable of forming colored wax speckles in the confectionery composition, wherein the mixture comprises (a) about 2% to about 30% by weight liquid carrier; (b) about 50% to about 95% of the at least one wax; (c) about 0.1% to about 3% by weight of the at least one colorant; and (d) about 1% to about 20% by weight of the at least one emulsifier.

### Embodiment 39

The multi-region confectionery composition of embodiment 38 wherein the liquid carrier is water.

### Embodiment 40

The multi-region confectionery composition of embodiment 38 wherein the liquid carrier is glycerol.

### Embodiment 41

The multi-region confectionery composition of embodiments 38 to 40 wherein the at least one wax is selected from the group consisting of carnauba wax, beeswax, candelilla wax, spermaceti wax and combinations thereof.

### Embodiment 42

The multi-region confectionery composition of embodiments 38 to 41 wherein the at least one colorant is at least one lake.

### Embodiment 43

The multi-region confectionery composition of embodiments 38 to 42 wherein the at least one colorant is at least one dye.

### Embodiment 44

The multi-region confectionery composition of embodiments 38 to 43 wherein the at least one emulsifier is a mixture of lecithin and glycerol monostearate, wherein the weight ratio of the lecithin to glycerol monostearate is from about 1:10 to about 10:1.

### Embodiment 45

The multi-region confectionery composition of embodiments 38 to 44 wherein the wherein the colored wax composition is made from particles having an average particle size of about 200 microns to about 1000 microns.

### Embodiment 46

The multi-region confectionery composition of embodiments 41 to 45 wherein the aqueous mixture comprises (a) about 3% to about 20% by weight water; (b) about 55% to about 90% of the at least one wax; (c) about 0.3% to about 2% by weight of the at least one colorant; and (d) about 2% to about 10% by weight of the at least one emulsifier.

### Embodiment 47

A method of making a speckled colored coated confectionery composition comprising the steps of: (a) providing a confectionery base having an outer surface; and (b) applying a colored wax composition to at least a portion of the outer surface of the confectionery base; the colored wax coating composition comprising a solidified liquid mixture of at least one liquid carrier, at least one wax, at least one colorant and at least one emulsifier and is capable of forming colored wax speckles in the confectionery composition, wherein the mixture comprises (a) about 2% to about 30% by weight liquid carrier; (b) about 50% to about 95% of the at least one wax; (c) about 0.1% to about 3% by weight of the at least one colorant; and (d) about 1% to about 20% by weight of the at least one emulsifier.

### Embodiment 48

The method of embodiment 47 wherein the liquid carrier is water.

### Embodiment 49

The method of embodiment 47 wherein the liquid carrier is glycerol.

### Embodiment 50

The method of embodiments 47 to 49 wherein the at least one wax is selected from the group consisting of carnauba wax, beeswax, candelilla wax, spermaceti wax and combinations thereof.

### Embodiment 51

The method of embodiments 47 to 50 wherein the at least one colorant is at least one lake.

### Embodiment 52

The method of embodiments 47 to 50 wherein the at least one colorant is at least one dye.

### Embodiment 53

The method of embodiments 47 to 52 wherein the at least one emulsifier is a mixture of lecithin and glycerol monostearate, wherein the weight ratio of the lecithin to glycerol monostearate is from about 1:10 to about 10:1.

### Embodiment 54

The method of embodiments 47 to 53 wherein the colored wax composition is made from particles having an average particle size of about 200 microns to about 1000 microns.

### Embodiment 55

The method of embodiments 47 to 54 wherein the confectionery base is a gum center and the confectionery composition is a chewing gum composition.

### Embodiment 56

The method of embodiment 55 wherein a third region is positioned between the confectionery base and the colored wax composition, said third region comprises at least one polyol coating.

### Embodiment 57

The method of embodiment 56 wherein the polyol coating comprises a sugarless sweetener selected from the group consisting of sorbitol, mannitol, isomalt, xylitol, maltitol, erythritol, lactitol and combinations thereof.

### Embodiment 58

The method of embodiments 56 or 57 wherein the amount of polyol coating coated onto the confectionery base is from about 10% to 100% by weight of the confectionery base.

### Embodiment 59

The method of embodiments 47 to 58 wherein the amount of colored wax coating composition is from about 0.005% to 1% by weight of the confectionery composition.

### Embodiment 60

The method of embodiments 47 to 59 wherein the mixture comprises (a) about 3% to about 20% by weight water; (b) about 55% to about 90% of the at least one wax; (c) about 0.3% to about 2% by weight of the at least one colorant; and (d) about 2% to about 10% by weight of the at least one emulsifier.

### Embodiment 61

The colored wax composition of embodiments 1 to 6 wherein the heating is carried out from about 60 degrees C. to about 80 degrees C.

### Embodiment 62

The multi-region confectionery composition of embodiments 7 to 16 wherein the heating is carried out from about 60 degrees C. to about 80 degrees C.

### Embodiment 63

The method of embodiments 18 to 27 wherein the heating is carried out from about 60 degrees C. to about 80 degrees C.

As used herein the terms “comprising” (also “comprises,” etc.), “having,” and “including” is inclusive (open-ended) and does not exclude additional, unrecited elements or method steps.

The singular forms “a,” “an,” and “the” include plural referents unless the context clearly dictates otherwise.

The endpoints of all ranges directed to the same characteristic or component are independently combinable, and inclusive of the recited endpoint.

The term “combination” is inclusive of a homogenous or non-homogenous blend, mixture, or alloy of the named components into an integrated whole. The term “homogenous” refers to a uniform blend of the components. The term “multiplicity” means more than one.

The word “or” means “and/or.”

Providing can be accomplished by a manufacturer, distributor, or other seller that makes the product available to the consumer.

Instructing can be by means of packaging, package inserts, advertisements, web sites, and the like.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A colored wax composition comprising a multiplicity of colored wax particles comprising at least one wax, at least one colorant and at least one emulsifier, wherein the colored wax particles are made by heating the at least one wax, the at least one colorant and the at least one emulsifier together, solidifying the heated colored wax composition and then forming particles from the solidified colored wax composition, the resultant colored wax particles having an average particle size of at least 200 microns and are capable of forming speckles in a confectionery product.

2. The colored wax composition of claim 1 wherein the at least one wax is selected from the group consisting of carnauba wax, beeswax, candelilla wax, spermaceti wax and combinations thereof.

3. The colored wax composition of claim 1 wherein the at least one colorant is at least one lake or at least one dye and wherein the at least one emulsifier is a mixture of lecithin and glycerol monostearate, wherein the weight ratio of the lecithin to glycerol monostearate is from about 1:10 to about 10:1.

4. (canceled)

5. (canceled)

6. The colored wax composition of claim 1 wherein the average particle size of the at least one wax is from about 400 microns to about 1000 microns.

7. A multi-region confectionery composition comprising:
a first region comprising a confectionery base; and
a second region at least partially surrounding the first region, the second region comprising a multiplicity of colored wax particles comprising at least one wax, at least one colorant and at least one emulsifier, wherein the colored wax particles are made by heating the at least one wax, the at least one colorant and the at least one emulsifier together, solidifying the heated colored wax composition and then forming particles from the solidified colored wax composition, the resultant colored wax particles having an average particle size of at least 200 microns and are capable of forming speckles in the multi-region confectionery composition.

8. (canceled)

9. (canceled)

10. (canceled)

11. (canceled)

12. (canceled)

13. The multi-region confectionery composition of claims 7 to 12 claim 7 wherein the first region is a gum center and the multi-region confectionery composition is a chewing gum composition.

14. The multi-region confectionery composition of claim 13 wherein a third region is positioned between the first region and the second region, said third region comprises at least one polyol coating.

15. (canceled)

16. (canceled)

17. (canceled)

18. A method of making a speckled colored coated confectionery composition comprising the steps of:
(a) providing a confectionery base having an outer surface; and
(b) applying a colored wax composition to at least a portion of the outer surface of the confectionery base; the colored wax composition comprising a multiplicity of colored wax particles comprising at least one wax, at least one colorant and at least one emulsifier, wherein the colored wax particles are made by heating the at least one wax, the at least one colorant and the at least one emulsifier together, solidifying the heated colored wax composition and then forming particles from the solidified colored wax composition, the resultant colored wax particles having an average particle size of at least 200 microns and are capable of forming speckles in the confectionery product.

19. The method of claim 18 wherein the at least one wax is selected from the group consisting of carnauba wax, beeswax, candelilla wax, spermaceti wax and combinations thereof.

20. The method of claim 18 wherein the at least one colorant is at least one lake or at least one dye and wherein the at least one emulsifier is a mixture of lecithin and glycerol monostearate, wherein the weight ratio of the lecithin to glycerol monostearate is from about 1:10 to about 10:1 and wherein the average particle size of the at least one wax is from about 400 microns to about 1000 microns.

21. (canceled)

22. (canceled)

23. (canceled)

24. The method of claim 18 wherein the confectionery base is a gum center and the confectionery composition is a chewing gum composition.

25. The method of claim 24 wherein a third region is positioned between the confectionery base and the colored wax composition, said third region comprises at least one polyol coating.

26. (canceled)

27. (canceled)

28. (canceled)

29. A colored wax composition comprising:
a solidified liquid mixture of at least one liquid carrier, at least one wax, at least one colorant and at least one emulsifier and is capable of forming colored wax speckles in a confectionery product, wherein the mixture comprises (a) about 2% to about 30% by weight liquid carrier; (b) about 50% to about 95% of the at least one wax; (c) about 0.1% to about 3% by weight of the at least one colorant; and (d) about 1% to about 20% by weight of the at least one emulsifier.

30. The colored wax composition of claims 29 wherein the liquid carrier is either water or glycerol.

31. (canceled)

32. (canceled)

33. (canceled)

34. (canceled)

35. (canceled)

36. (canceled)

37. (canceled)

38. A multi-region confectionery composition comprising:
a first region comprising a confectionery base; and
a second region at least partially surrounding the first region, the second region comprising a colored wax composition, wherein the colored wax composition is a solidified liquid mixture of at least one liquid carrier, at least one wax, at least one colorant and at least one emulsifier and is capable of forming colored wax speckles in the confectionery composition, wherein the mixture comprises (a) about 2% to about 30% by weight liquid carrier; (b) about 50% to about 95% of the at least one wax; (c) about 0.1% to about 3% by weight of the at least one colorant; and (d) about 1% to about 20% by weight of the at least one emulsifier.

39. (canceled)

40. (canceled)

41. (canceled)

42. (canceled)

43. (canceled)

44. (canceled)

45. (canceled)

46. (canceled)

47. A method of making a speckled colored coated confectionery composition comprising the steps of:
(a) providing a confectionery base having an outer surface; and
(b) applying a colored wax composition to at least a portion of the outer surface of the confectionery base; the colored wax coating composition comprising a solidified liquid mixture of at least one liquid carrier, at least one wax, at least one colorant and at least one emulsifier and is capable of forming colored wax speckles in the confectionery composition, wherein the mixture comprises (a) about 2% to about 30% by weight liquid carrier; (b) about 50% to about 95% of the at least one wax; (c) about 0.1% to about 3% by weight of the at least one colorant; and (d) about 1% to about 20% by weight of the at least one emulsifier.

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. The colored wax composition of claim 1 wherein the heating is carried out from 60 degrees C. to 80 degrees C.

62. The multi-region confectionery composition of claim 7 wherein the heating is carried out from 60 degrees C. to 80 degrees C.

63. The method of claim 18 wherein the heating is carried out from 60 degrees C. to 80 degrees C.
